(19) United States
(12) Patent Application Publication
(10) Pub. No.: US 2015/0105524 A1
(43) Pub. Date: Apr. 16, 2015

(54) Method of Improving the Melt Properties of Poly(Arylene Sulfide) Polymers

(71) Applicant: Chevron Phillips Chemical Company LP, The Woodlands, TX (US)

(72) Inventors: Thomas M. CLARK, Bartlesville, OK (US); R. Shawn CHILDRESS, Bartlesville, OK (US); Jeffrey S. FODOR, Bartlesville, OK (US); Jeffrey L. SWAN, Pawhuska, OK (US)

(73) Assignee: Chevron Phillips Chemical Company LP, The Woodlands, TX (US)

(21) Appl. No.: 14/053,358

(22) Filed: Oct. 14, 2013

(51) Int. Cl. C08G 75/14

(52) U.S. Cl. CPC C08G 75/14
USPC 525/537

(57) ABSTRACT

A process comprising (a) beginning with a poly(arylene sulfide) polymer comprising a plurality of small poly(arylene sulfide) polymer particles and large poly(arylene sulfide) polymer particles, distinguishing at least a portion of the small poly(arylene sulfide) polymer particles from the large poly(arylene sulfide) polymer particles to yield distinguished small poly(arylene sulfide) polymer particles, wherein the small poly(arylene sulfide) polymer particles have a particle size of less than 2.38 mm and the large poly(arylene sulfide) polymer particles have a particle size of equal to or greater than 2.38 mm, and (b) contacting at least a portion of the distinguished small poly(arylene sulfide) polymer particles with an aqueous solution to form treated small poly(arylene sulfide) polymer particles.

### TECHNICAL FIELD

The present disclosure relates to a method of improving the melt properties of poly(arylene sulfide) polymers. More specifically, the present disclosure relates to a method of using aqueous solutions for treating poly(arylene sulfide) polymer particles for improving the melt properties of the poly(arylene sulfide) polymers.

### BACKGROUND

Polymers, such as poly(phenylene sulfide) and its derivatives, are used for the production of a wide variety of articles. The use of a particular polymer in a particular application will depend on the type of physical and/or mechanical properties displayed by the polymer, and such properties are generally a result of the method used for producing a particular polymer, e.g., the reaction conditions under which the polymer is produced. Thus, there is an ongoing need to develop and improve methods for producing these polymers.

### BRIEF SUMMARY

Disclosed herein is a process comprising (a) beginning with a poly(arylene sulfide) polymer comprising a plurality of small poly(arylene sulfide) polymer particles and large poly(arylene sulfide) polymer particles, distinguishing at least a portion of the small poly(arylene sulfide) polymer particles from the large poly(arylene sulfide) polymer particles to yield distinguished small poly(arylene sulfide) polymer particles, wherein the small poly(arylene sulfide) polymer particles have a particle size of less than 2.38 mm and the large poly(arylene sulfide) polymer particles have a particle size of equal to or greater than 2.38 mm, and (b) contacting at least a portion of the distinguished small poly(arylene sulfide) polymer particles with an aqueous solution to form treated small poly(arylene sulfide) polymer particles.

Also disclosed herein is a process comprising (a) beginning with a poly(arylene sulfide) polymer comprising a plurality of small poly(arylene sulfide) polymer particles and large poly(arylene sulfide) polymer particles, distinguishing at least a portion of the small poly(arylene sulfide) polymer particles from the large poly(arylene sulfide) polymer particles to yield distinguished small poly(arylene sulfide) polymer particles, wherein the small poly(arylene sulfide) polymer particles have a particle size of less than 2.38 mm and the large poly(arylene sulfide) polymer particles have a particle size of equal to or greater than 2.38 mm, and (b) contacting at least a portion of the distinguished small poly(arylene sulfide) polymer particles with an aqueous acid solution to form acid treated small poly(arylene sulfide) polymer particles, wherein the aqueous acid solution has a pH of from about 1 to about 8.

Further disclosed herein is a process comprising (a) beginning with a poly(phenylene sulfide) polymer comprising a plurality of small poly(phenylene sulfide) polymer particles and large poly(phenylene sulfide) polymer particles, distinguishing at least a portion of the small poly(phenylene sulfide) polymer particles from the large poly(phenylene sulfide) polymer particles to yield distinguished small poly(phenylene sulfide) polymer particles, wherein the small poly(phenylene sulfide) polymer particles have a particle size of less than 2.38 mm and the large poly(phenylene sulfide) polymer particles have a particle size of equal to or greater than 2.38 mm, and (b) contacting at least a portion of the distinguished small poly(phenylene sulfide) polymer particles with an aqueous acetic acid solution to form acid treated small poly(phenylene sulfide) polymer particles, wherein the aqueous acetic acid solution has a pH of from about 1 to about 8.

Further disclosed herein is a process comprising (a) beginning with a poly(phenylene sulfide) polymer comprising a plurality of small poly(phenylene sulfide) polymer particles and large poly(phenylene sulfide) polymer particles, distinguishing at least a portion of the small poly(phenylene sulfide) polymer particles from the large poly(phenylene sulfide) polymer particles to yield distinguished small poly(phenylene sulfide) polymer particles, wherein the small poly(phenylene sulfide) polymer particles have a particle size of less than 2.38 mm and the large poly(phenylene sulfide) polymer particles have a particle size of equal to or greater than 2.38 mm, and (b) contacting at least a portion of the distinguished small poly(phenylene sulfide) polymer particles with an aqueous metal cation solution to form metal cation treated small poly(phenylene sulfide) polymer particles, wherein the metal cation comprises a calcium cation.

Further disclosed herein is a process comprising (a) beginning with a poly(arylene sulfide) polymer comprising a plurality of small poly(arylene sulfide) polymer particles and large poly(arylene sulfide) polymer particles, distinguishing at least a portion of the small poly(arylene sulfide) polymer particles from the large poly(arylene sulfide) polymer particles to yield distinguished small poly(arylene sulfide) polymer particles, wherein the small poly(arylene sulfide) polymer particles have a particle size of less than 2.38 mm and the large poly(arylene sulfide) polymer particles have a particle size of equal to or greater than 2.38 mm, and (b) contacting at least a portion of the distinguished small poly(arylene sulfide) polymer particles with an aqueous metal cation solution to form metal cation treated small poly(arylene sulfide) polymer particles, wherein the metal cation comprises a calcium cation.

### BRIEF DESCRIPTION OF THE DRAWINGS

FIGS. 1A, 1B and 1C display process flow diagrams for distinguishing small poly(arylene sulfide) polymer particles from large poly(arylene sulfide) polymer particles.

### DETAILED DESCRIPTION

Disclosed herein are methods of treating poly(arylene sulfide) polymers to improve the melt properties of the poly(arylene sulfide) polymer. The present application relates to poly(arylene sulfide) polymer, also referred to herein simply as “poly(arylene sulfide).” In the various embodiments disclosed herein, it is to be expressly understood that reference to poly(arylene sulfide) polymer specifically includes, without limitation, polyphenylene sulfide polymer (or simply, polyphenylene sulfide), also referred to as PPS polymer (or simply, PPS). In an embodiment, the poly(arylene sulfide) polymer comprises poly(arylene sulfide) polymer particles, for example particles of varying sizes such as large poly(arylene sulfide) particles having a particle size of equal to or greater than about 2.38 mm and small poly(arylene sulfide) polymer particles having a particle size of less than about 2.38 mm. In an embodiment, the poly(arylene sulfide) polymer comprises a particle size distribution having equal to or greater than about 10 weight percent (wt. %) large poly(arylene sulfide) particles. In an embodiment, the poly(arylene sulfide) polymer particles can undergo one or more steps to distinguish small poly(arylene sulfide) particles from large poly(arylene sulfide) particles prior to, concurrent with, and/or subsequent to treatment to improve the melt properties of the poly(arylene sulfide) polymer. For example, the poly(arylene sulfide) polymer particles can undergo a step to distinguish small poly(arylene sulfide) polymer particles from large poly(arylene sulfide) polymer particles prior to treatment to improve the melt properties of the poly(arylene sulfide) polymer. For purposes of the disclosure herein, distinguishing poly(arylene sulfide) polymer particles will be understood to include, but is not limited to, separating the poly(arylene sulfide) polymer particles based on their size (e.g., sifting, sieving, etc.); and/or mechanically reducing the size of (e.g., grinding) large poly(arylene sulfide) polymer particles to obtain small poly(arylene sulfide) polymer particles.

In an embodiment, a method of the present disclosure comprises treating poly(arylene sulfide) polymer particles with an aqueous solution (e.g., water, tap water, aqueous acid solution, aqueous metal cation solution, etc.) to improve the melt properties of the poly(arylene sulfide) polymer, for example by contacting the poly(arylene sulfide) polymer particles with an aqueous solution (e.g., water, tap water, aqueous acid solution, aqueous metal cation solution, etc.) to yield treated poly(arylene sulfide) polymer particles (e.g., acid treated poly(arylene sulfide) polymer particles, metal cation treated poly(arylene sulfide) polymer particles, etc.). While the present disclosure will be discussed in detail in the context of treating poly(arylene sulfide) polymer particles with an aqueous solution to improve the melt properties of the poly(arylene sulfide) polymer, it should be understood that other polymers can be treated with an aqueous solution to improve the melt properties of such polymers. In an embodiment, such methods can result in polymers with desirable properties, e.g., melt crystallization temperature, sodium content, etc.

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2nd Ed (1997) can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Groups of elements of the table are indicated using the numbering scheme indicated in the version of the periodic table of elements published in Chemical and Engineering News, 63(5), 27, 1985. In some instances a group of elements can be indicated using a common name assigned to the group; for example alkali earth metals (or alkali metals) for Group 1 elements, alkaline earth metals (or alkaline metals) for Group 2 elements, transition metals for Group 3-12 elements, and halogens for Group 17 elements.

A chemical “group” is described according to how that group is formally derived from a reference or “parent” compound, for example, by the number of hydrogen atoms formally removed from the parent compound to generate the group, even if that group is not literally synthesized in this manner. These groups can be utilized as substituents or coordinated or bonded to metal atoms. By way of example, an “alkyl group” formally can be derived by removing one hydrogen atom from an alkane, while an “alkylene group” formally can be derived by removing two hydrogen atoms from an alkane. Moreover, a more general term can be used to encompass a variety of groups that formally are derived by removing any number (“one or more”) hydrogen atoms from a parent compound, which in this example can be described as an “alkane group,” and which encompasses an “alkyl group,” an “alkylene group,” and materials have three or more hydrogens atoms, as necessary for the situation, removed from the alkane. Throughout, the disclosure that a substituent, ligand, or other chemical moiety can constitute a particular “group” implies that the well-known rules of chemical structure and bonding are followed when that group is employed as described. When describing a group as being “derived by,” “derived from,” “formed by,” or “formed from,” such terms are used in a formal sense and are not intended to reflect any specific synthetic methods or procedure, unless specified otherwise or the context requires otherwise.

The term “substituted” when used to describe a group, for example, when referring to a substituted analog of a particular group, is intended to describe any non-hydrogen moiety that formally replaces a hydrogen in that group, and is intended to be non-limiting. A group or groups can also be referred to herein as “unsubstituted” or by equivalent terms such as “non-substituted,” which refers to the original group in which a non-hydrogen moiety does not replace a hydrogen within that group. “Substituted” is intended to be non-limiting and include inorganic substituents or organic substituents.

Unless otherwise specified, any carbon-containing group for which the number of carbon atoms is not specified can have, according to proper chemical practice, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 carbon atoms, or any range or combination of ranges between these values. For example, unless otherwise specified, any carbon-containing group can have from 1 to 30 carbon atoms, from 1 to 25 carbon atoms, from 1 to 20 carbon atoms, from 1 to 15 carbon atoms, from 1 to 10 carbon atoms, or from 1 to 5 carbon atoms, and the like. Moreover, other identifiers or qualifying terms can be utilized to indicate the presence or absence of a particular substituent, a particular regiochemistry and/or stereochemistry, or the presence or absence of a branched underlying structure or backbone.

Within this disclosure the normal rules of organic nomenclature will prevail. For instance, when referencing substituted compounds or groups, references to substitution patterns are taken to indicate that the indicated group(s) is (are) located at the indicated position and that all other non-indicated positions are hydrogen. For example, reference to a 4-substituted phenyl group indicates that there is a non-hydrogen substituent located at the 4 position and hydrogens located at the 2, 3, 5, and 6 positions. By way of another example, reference to a 3-subtituted naphth-2-yl indicates that there is a non-hydrogen substituent located at the 3 position and hydrogens located at the 1, 4, 5, 6, 7, and 8 positions. References to compounds or groups having substitutions at positions in addition to the indicated position will be reference using comprising or some other alternative language. For example, a reference to a phenyl group comprising a substituent at the 4 position refers to a group having a non-hydrogen atom at the 4 position and hydrogen or any non-hydrogen group at the 2, 3, 5, and 6 positions.

The term “organyl group” is used herein in accordance with the definition specified by IUPAC: an organic substituent group, regardless of functional type, having one free valence at a carbon atom. Similarly, an “organylene group” refers to an organic group, regardless of functional type, derived by removing two hydrogen atoms from an organic compound, either two hydrogen atoms from one carbon atom or one hydrogen atom from each of two different carbon atoms. An “organic group” refers to a generalized group formed by removing one or more hydrogen atoms from carbon atoms of an organic compound. Thus, an “organyl group,” an “organylene group,” and an “organic group” can contain organic functional group(s) and/or atom(s) other than carbon and hydrogen, that is, an organic group that can comprise functional groups and/or atoms in addition to carbon and hydrogen. For instance, non-limiting examples of atoms other than carbon and hydrogen include halogens, oxygen, nitrogen, phosphorus, and the like. Non-limiting examples of functional groups include ethers, aldehydes, ketones, esters, sulfides, amines, and phosphines, and so forth. In one aspect, the hydrogen atom(s) removed to form the “organyl group,” “organylene group,” or “organic group” can be attached to a carbon atom belonging to a functional group, for example, an acyl group (—C(O)R), a formyl group (—C(O)H), a carboxy group (—C(O)OH), a hydrocarboxycarbonyl group (—C(O)OR), a cyano group (—C≡N), a carbamoyl group (—C(O)NH₂), a N-hydrocarbylcarbamoyl group (—C(O)NHR), or N,N′-dihydrocarbylcarbamoyl group (—C(O)NR₂), among other possibilities. In another aspect, the hydrogen atom(s) removed to form the “organyl group,” “organylene group,” or “organic group” can be attached to a carbon atom not belonging to, and remote from, a functional group, for example, —CH₂C(O)CH₃, —CH₂NR₂. An “organyl group,” “organylene group,” or “organic group” can be aliphatic, inclusive of being cyclic or acyclic, or can be aromatic. “Organyl groups,” “organylene groups,” and “organic groups” also encompass heteroatom-containing rings, heteroatom-containing ring systems, heteroaromatic rings, and heteroaromatic ring systems. “Organyl groups,” “organylene groups,” and “organic groups” can be linear or branched unless otherwise specified. Finally, it is noted that the “organyl group,” “organylene group,” or “organic group” definitions include “hydrocarbyl group,” “hydrocarbylene group,” “hydrocarbon group,” respectively, and “alkyl group,” “alkylene group,” and “alkane group,” respectively, as members.

The term “hydrocarbon” whenever used in this specification and claims refers to a compound containing only carbon and hydrogen. Other identifiers can be utilized to indicate the presence of particular groups in the hydrocarbon (e.g. halogenated hydrocarbon indicates the presence of one or more halogen atoms replacing an equivalent number of hydrogen atoms in the hydrocarbon). The term “hydrocarbyl group” is used herein in accordance with the definition specified by IUPAC: a univalent group formed by removing a hydrogen atom from a hydrocarbon (that is, a group containing only carbon and hydrogen). Similarly, a “hydrocarbylene group” refers to a group formed by removing two hydrogen atoms from a hydrocarbon, either two hydrogen atoms from one carbon atom or one hydrogen atom from each of two different carbon atoms. Therefore, in accordance with the terminology used herein, a “hydrocarbon group” refers to a generalized group formed by removing one or more hydrogen atoms (as necessary for the particular group) from a hydrocarbon. A “hydrocarbyl group,” “hydrocarbylene group,” and “hydrocarbon group” can be acyclic or cyclic groups, and/or can be linear or branched. A “hydrocarbyl group,” “hydrocarbylene group,” and “hydrocarbon group” can include rings, ring systems, aromatic rings, and aromatic ring systems, which contain only carbon and hydrogen. “Hydrocarbyl groups,” “hydrocarbylene groups,” and “hydrocarbon groups” include, by way of example, aryl, arylene, arene groups, alkyl, alkylene, alkane group, cycloalkyl, cycloalkylene, cycloalkane groups, aralkyl, aralkylene, and aralkane groups, respectively, among other groups as members.

The term “alkane” whenever used in this specification and claims refers to a saturated hydrocarbon compound. Other identifiers can be utilized to indicate the presence of particular groups in the alkane (e.g. halogenated alkane indicates the presence of one or more halogen atoms replacing an equivalent number of hydrogen atoms in the alkane). The term “alkyl group” is used herein in accordance with the definition specified by IUPAC: a univalent group formed by removing a hydrogen atom from an alkane. Similarly, an “alkylene group” refers to a group formed by removing two hydrogen atoms from an alkane (either two hydrogen atoms from one carbon atom or one hydrogen atom from two different carbon atoms). An “alkane group” is a general term that refers to a group formed by removing one or more hydrogen atoms (as necessary for the particular group) from an alkane. An “alkyl group,” “alkylene group,” and “alkane group” can be acyclic or cyclic groups, and/or can be linear or branched unless otherwise specified.

A “cycloalkane” is a saturated cyclic hydrocarbon, with or without side chains, for example, cyclobutane. Other identifiers can be utilized to indicate the presence of particular groups in the cycloalkane (e.g. halogenated cycloalkane indicates the presence of one or more halogen atoms replacing an equivalent number of hydrogen atoms in the cycloalkane). Unsaturated cyclic hydrocarbons having one or more endocyclic double or triple bonds are called cycloalkenes and cycloalkynes, respectively. Cycloalkenes and cycloalkynes having only one, only two, and only three endocyclic double or triple bonds, respectively, can be identified by use of the term “mono,” “di,” and “tri within the name of the cycloalkene or cycloalkyne. Cycloalkenes and cycloalkynes can further identify the position of the endocyclic double or triple bonds. Other identifiers can be utilized to indicate the presence of particular groups in the cycloalkane (e.g. halogenated cycloalkane indicates that the presence of one or more halogen atoms replacing an equivalent number of hydrogen atoms in the cycloalkane).

A “cycloalkyl group” is a univalent group derived by removing a hydrogen atom from a ring carbon atom from a cycloalkane. For example, a 1-methylcyclopropyl group and a 2-methylcyclopropyl group are illustrated as follows.

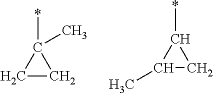

Similarly, a “cycloalkylene group” refers to a group derived by removing two hydrogen atoms from a cycloalkane, at least one of which is a ring carbon. Thus, a “cycloalkylene group” includes both a group derived from a cycloalkane in which two hydrogen atoms are formally removed from the same ring carbon, a group derived from a cycloalkane in which two hydrogen atoms are formally removed from two different ring carbons, and a group derived from a cycloalkane in which a first hydrogen atom is formally removed from a ring carbon and a second hydrogen atom is formally removed from a carbon atom that is not a ring carbon. A “cycloalkane group” refers to a generalized group formed by removing one or more hydrogen atoms (as necessary for the particular group and at least one of which is a ring carbon) from a cycloalkane. It should be noted that according to the definitions provided herein, general cycloalkane groups (including cycloalkyl groups and cycloalkylene groups) include those having zero, one, or more than one hydrocarbyl substituent groups attached to a cycloalkane ring carbon atom (e.g. a methylcyclopropyl group) and is member of the group of hydrocarbon groups. However, when referring to a cycloalkane group having a specified number of cycloalkane ring carbon atoms (e.g. cyclopentane group or cyclohexane group, among others), the base name of the cycloalkane group having a defined number of cycloalkane ring carbon atoms refers to the unsubstituted cycloalkane group. Consequently, a substituted cycloalkane group having a specified number of ring carbon atoms (e.g. substituted cyclopentane or substituted cyclohexane, among others) refers to the respective group having one or more substituent groups (including halogens, hydrocarbyl groups, or hydrocarboxy groups, among other substituent groups) attached to a cycloalkane group ring carbon atom. When the substituted cycloalkane group having a defined number of cycloalkane ring carbon atoms is a member of the group of hydrocarbon groups (or a member of the general group of cycloalkane groups), each substituent of the substituted cycloalkane group having a defined number of cycloalkane ring carbon atoms is limited to hydrocarbyl substituent group. One can readily discern and select general groups, specific groups, and/or individual substituted cycloalkane group(s) having a specific number of ring carbons atoms which can be utilized as member of the hydrocarbon group (or a member of the general group of cycloalkane groups).

An aromatic compound is a compound containing a cyclically conjugated double bond system that follows the Hückel (4n+2) rule and contains (4n+2) pi-electrons, where n is an integer from 1 to 5. Aromatic compounds include “arenes” (hydrocarbon aromatic compounds) and “heteroarenes,” also termed “hetarenes” (heteroaromatic compounds formally derived from arenes by replacement of one or more methine (—C═) carbon atoms of the cyclically conjugated double bond system with a trivalent or divalent heteroatoms, in such a way as to maintain the continuous pi-electron system characteristic of an aromatic system and a number of out-of-plane pi-electrons corresponding to the Hückel rule (4n+2). While arene compounds and heteroarene compounds are mutually exclusive members of the group of aromatic compounds, a compound that has both an arene group and a heteroarene group are generally considered a heteroarene compound. Aromatic compounds, arenes, and heteroarenes can be monocyclic (e.g., benzene, toluene, furan, pyridine, methylpyridine) or polycyclic unless otherwise specified. Polycyclic aromatic compounds, arenes, and heteroarenes, include, unless otherwise specified, compounds wherein the aromatic rings can be fused (e.g., naphthalene, benzofuran, and indole), compounds where the aromatic groups can be separate and joined by a bond (e.g., biphenyl or 4-phenylpyridine), or compounds where the aromatic groups are joined by a group containing linking atoms (e.g., carbon—the methylene group in diphenylmethane; oxygen—diphenyl ether; nitrogen—triphenyl amine; among others linking groups). As disclosed herein, the term “substituted” can be used to describe an aromatic group, arene, or heteroarene wherein a non-hydrogen moiety formally replaces a hydrogen in the compound, and is intended to be non-limiting.

An “aromatic group” refers to a generalized group formed by removing one or more hydrogen atoms (as necessary for the particular group and at least one of which is an aromatic ring carbon atom) from an aromatic compound. For a univalent “aromatic group,” the removed hydrogen atom must be from an aromatic ring carbon. For an “aromatic group” formed by removing more than one hydrogen atom from an aromatic compound, at least one hydrogen atom must be from an aromatic hydrocarbon ring carbon. Additionally, an “aromatic group” can have hydrogen atoms removed from the same ring of an aromatic ring or ring system (e.g., phen-1,4-ylene, pyridin-2,3-ylene, naphth-1,2-ylene, and benzofuran-2,3-ylene), hydrogen atoms removed from two different rings of a ring system (e.g., naphth-1,8-ylene and benzofuran-2,7-ylene), or hydrogen atoms removed from two isolated aromatic rings or ring systems (e.g., bis(phen-4-ylene)methane).

An arene is aromatic hydrocarbon, with or without side chains (e.g. benzene, toluene, or xylene, among others). An “aryl group” is a group derived by the formal removal of a hydrogen atom from an aromatic ring carbon of an arene. It should be noted that the arene can contain a single aromatic hydrocarbon ring (e.g., benzene, or toluene), contain fused aromatic rings (e.g., naphthalene or anthracene), and/or contain one or more isolated aromatic rings covalently linked via a bond (e.g., biphenyl) or non-aromatic hydrocarbon group(s) (e.g., diphenylmethane). One example of an “aryl group” is ortho-tolyl (o-tolyl), the structure of which is shown here.

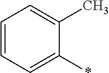 [SMILES: *c1ccccc1C]

Similarly, an “arylene group” refers to a group formed by removing two hydrogen atoms (at least one of which is from an aromatic ring carbon) from an arene. An “arene group” refers to a generalized group formed by removing one or more hydrogen atoms (as necessary for the particular group and at least one of which is an aromatic ring carbon) from an arene. However, if a group contains separate and distinct arene and heteroarene rings or ring systems (e.g., the phenyl and benzofuran moieties in 7-phenylbenzofuran) its classification depends upon the particular ring or ring system from which the hydrogen atom was removed, that is, a substituted arene group if the removed hydrogen came from the aromatic hydrocarbon ring or ring system carbon atom (e.g., the 2 carbon atom in the phenyl group of 6-phenylbenzofuran) and a heteroarene group if the removed hydrogen carbon came from a heteroaromatic ring or ring system carbon atom (e.g., the 2 or 7 carbon atom of the benzofuran group of 6-phenylbenzofuran). It should be noted that according the definitions provided herein, general arene groups (including an aryl group and an arylene group) include those having zero, one, or more than one hydrocarbyl substituent groups located on an aromatic hydrocarbon ring or ring system carbon atom (e.g., a toluene group or a xylene group, among others) and is a member of the group of hydrocarbon groups. However, a phenyl group (or phenylene group) and/or a naphthyl group (or naphthylene group) refer to the specific unsubstituted arene groups. Consequently, a substituted phenyl group or substituted naphthyl group refers to the respective arene group having one or more substituent groups (including halogens, hydrocarbyl groups, or hydrocarboxy groups, among others) located on an aromatic hydrocarbon ring or ring system carbon atom. When the substituted phenyl group and/or substituted naphthyl group is a member of the group of hydrocarbon groups (or a member of the general group of arene groups), each substituent is limited to a hydrocarbyl substituent group. One having ordinary skill in the art can readily discern and select general phenyl and/or naphthyl groups, specific phenyl and/or naphthyl groups, and/or individual substituted phenyl or substituted naphthyl groups which can be utilized as a member of the group of hydrocarbon groups (or a member of the general group of arene groups).

Regarding claim transitional terms or phrases, the transitional term “comprising”, which is synonymous with “including,” “containing,” “having,” or “characterized by,” is inclusive or open-ended and does not exclude additional, unrecited elements or method steps. The transitional phrase “consisting of” excludes any element, step, or ingredient not specified in the claim. The transitional phrase “consisting essentially of” limits the scope of a claim to the specified materials or steps and those that do not materially affect the basic and novel characteristic(s) of the claimed invention. The term “consisting essentially of” occupies a middle ground between closed terms like “consisting of” and fully open terms like “comprising.” Absent an indication to the contrary, when describing a compound or composition “consisting essentially of” is not to be construed as “comprising,” but is intended to describe the recited component that includes materials which do not significantly alter composition or method to which the term is applied. For example, a feedstock consisting essentially of a material A can include impurities typically present in a commercially produced or commercially available sample of the recited compound or composition. When a claim includes different features and/or feature classes (for example, a method step, feedstock features, and/or product features, among other possibilities), the transitional terms comprising, consisting essentially of, and consisting of apply only to feature class to which is utilized and it is possible to have different transitional terms or phrases utilized with different features within a claim. For example a method can comprise several recited steps (and other non-recited steps) but utilize a catalyst system preparation consisting of specific or alternatively consisting essentially of specific steps but utilize a catalyst system comprising recited components and other non-recited components.

While compositions and methods are described in terms of “comprising” (or other broad term) various components and/or steps, the compositions and methods can also described using narrower terms such as “consist essentially of” or “consist of” the various components and/or steps.

Use of the term “optionally” with respect to any element of a claim is intended to mean that the subject element is required, or alternatively, is not required. Both alternatives are intended to be within the scope of the claim.

The terms “a,” “an,” and “the” are intended, unless specifically indicated otherwise, to include plural alternatives, e.g., at least one. For any particular compound or group disclosed herein, any name or structure presented is intended to encompass all conformational isomers, regioisomers, and stereoisomers that can arise from a particular set of substituents, unless otherwise specified. For example, a general reference to pentane includes n-pentane, 2-methyl-butane, and 2,2-dimethylpropane and a general reference to a butyl group includes an n-butyl group, a sec-butyl group, an iso-butyl group, and t-butyl group. The name or structure also encompasses all enantiomers, diastereomers, and other optical isomers whether in enantiomeric or racemic forms, as well as mixtures of stereoisomers, as would be recognized by a skilled artisan, unless otherwise specified.

The terms “room temperature” or “ambient temperature” are used herein to describe any temperature from 15° C. to 35° C. wherein no external heat or cooling source is directly applied to the reaction vessel. Accordingly, the terms “room temperature” and “ambient temperature” encompass the individual temperatures and any and all ranges, subranges, and combinations of subranges of temperatures from 15° C. to 35° C. wherein no external heating or cooling source is directly applied to the reaction vessel. The term “atmospheric pressure” is used herein to describe an earth air pressure wherein no external pressure modifying means is utilized. Generally, unless practiced at extreme earth altitudes, “atmospheric pressure” is about 1 atmosphere (alternatively, about 14.7 psi or about 101 kPa).

Features within this disclosure that are provided as a minimum values can be alternatively stated as “at least” or “greater than or equal to” any recited minimum value for the feature disclosed herein. Features within this disclosure that are provided as a maximum values can be alternatively stated as “less than or equal to” any recited maximum value for the feature disclosed herein.

Embodiments disclosed herein can provide the materials listed as suitable for satisfying a particular feature of the embodiment delimited by the term “or.” For example, a particular feature of the disclosed subject matter can be disclosed as follows: Feature X can be A, B, or C. It is also contemplated that for each feature the statement can also be phrased as a listing of alternatives such that the statement “Feature X is A, alternatively B, or alternatively C” is also an embodiment of the present disclosure whether or not the statement is explicitly recited.

In an embodiment, the polymers disclosed herein are poly(arylene sulfide) polymers. In an embodiment, the polymer can comprise a poly(arylene sulfide). In other embodiments, the polymer can comprise a poly(phenylene sulfide). Herein, the polymer refers both to a material collected as the product of a polymerization reaction (e.g., a reactor or virgin resin) and a polymeric composition comprising a polymer and one or more additives. In an embodiment, a monomer (e.g., p-dichlorobenzene) can be polymerized using the methodologies disclosed herein to produce a polymer of the type disclosed herein. In an embodiment, the polymer can comprise a homopolymer or a copolymer. It is to be understood that an inconsequential amount of comonomer can be present in the polymers disclosed herein and the polymer still be considered a homopolymer. Herein an inconsequential amount of a comonomer refers to an amount that does not substantively affect the properties of the polymer disclosed herein. For example a comonomer can be present in an amount of less than about 1.0 wt. %, 0.5 wt. %, 0.1 wt. %, or 0.01 wt. %, based on the total weight of polymer.

Generally, poly(arylene sulfide) is a polymer comprising a —(Ar—S)— repeating unit, wherein Ar is an arylene group. Unless otherwise specified the arylene groups of the poly(arylene sulfide) can be substituted or unsubstituted; alternatively, substituted; or alternatively, unsubstituted. Additionally, unless otherwise specified, the poly(arylene sulfide) can include any isomeric relationship of the sulfide linkages in polymer; e.g., when the arylene group is a phenylene group the sulfide linkages can be ortho, meta, para, or combinations thereof.

In an aspect, poly(arylene sulfide) can contain at least 5, 10, 20, 30, 40, 50, 60, 70 mole percent of the —(Ar—S)— unit. In an embodiment, the poly(arylene sulfide) can contain up to 50, 70, 80, 90, 95, 99, or 100 mole percent of the —(Ar—S)— unit. In some embodiments, poly(arylene sulfide) can contain from any minimum mole percent of the —(Ar—S)— unit disclosed herein to any maximum mole percent of the —(Ar—S)— unit disclosed herein; for example, from 5 to 99 mole percent, 30 to 70 mole percent, or 70 to 95 mole percent of the —(Ar—S)— unit. Other ranges for the poly(arylene sulfide) units are readily apparent from the present disclosure. Poly(arylene sulfide) containing less than 100 percent —(Ar—S)— can further comprise units having one or more of the following structures, wherein (*) as used throughout the disclosure represents a continuing portion of a polymer chain or terminal group:

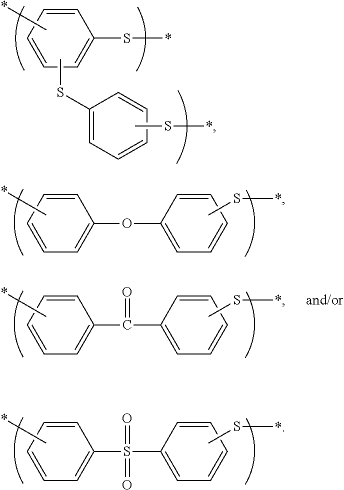

In an embodiment, the arylene sulfide unit can be represented by Formula I.

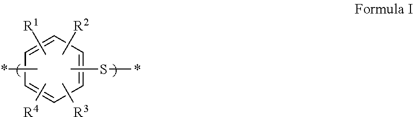

It should be understood, that within the arylene sulfide unit having Formula I, the relationship between the position of the sulfur atom of the arylene sulfide unit and the position where the next arylene sulfide unit can be ortho, meta, para, or any combination thereof. Generally, the identity of R¹, R², R³, and R⁴ are independent of each other and can be any group described herein.

In an embodiment, R¹, R², R³, and R⁴ independently can be hydrogen or a substituent. In some embodiments, each substituent independently can be an organyl group, an organocarboxy group, or an organothio group; alternatively, an organyl group or an organocarboxy group; alternatively, an organyl group or an organothio group; alternatively, an organyl group; alternatively, an organocarboxy group; or alternatively, or an organothio group. In other embodiments, each substituent independently can be a hydrocarbyl group, a hydrocarboxy group, or a hydrocarbylthio group; alternatively, a hydrocarbyl group or a hydrocarboxy group; alternatively, a hydrocarbyl group or a hydrocarbylthio group; alternatively, a hydrocarbyl group; alternatively, a hydrocarboxy group; or alternatively, or a hydrocarbylthio group. In yet other embodiments, each substituent independently can be an alkyl group, an alkoxy group, or an alkylthio group; alternatively, an alkyl group or an alkoxy group; alternatively, an alkyl group or an alkylthio group; alternatively, an alkyl group; alternatively, an alkoxy group; or alternatively, or an alkylthio group.

In an embodiment, each organyl group which can be utilized as R¹, R², R³, and/or R⁴ independently can be a C₁ to C₂₀ organyl group; alternatively, a C₁ to C₁₀ organyl group; or alternatively, a C₁ to C₅ organyl group. In an embodiment, each organocarboxy group which can be utilized as R¹, R², R³, and/or R⁴ independently can be a C₁ to C₂₀ organocarboxy group; alternatively, a C₁ to C₁₀ organocarboxy group; or alternatively, a C₁ to C₅ organocarboxy group. In an embodiment, each organothio group which can be utilized as R¹, R², R³, and/or R⁴ independently can be a C₁ to C₂₀ organothio group; alternatively, a C₁ to C₁₀ organothio group; or alternatively, a C₁ to C₅ organothio group. In an embodiment, each hydrocarbyl group which can be utilized as R¹, R², R³, and/or R⁴ independently can be a C₁ to C₂₀ hydrocarbyl group; alternatively, a C₁ to C₁₀ hydrocarbyl group; or alternatively, a C₁ to C₅ hydrocarbyl group. In an embodiment, each hydrocarboxy group which can be utilized as R¹, R², R³, and/or R⁴ independently can be a C₁ to C₂₀ hydrocarboxy group; alternatively, a C₁ to C₁₀ hydrocarboxy group; or alternatively, a C₁ to C₅ hydrocarboxy group. In an embodiment, each hydrocarbyl group which can be utilized as R¹, R², R³, and/or R⁴ independently can be a C₁ to C₂₀ hydrocarbylthio group; alternatively, a C₁ to C₁₀ hydrocarbylthio group; or alternatively, a C₁ to C₅ hydrocarbylthio group. In an embodiment, each alkyl group which can be utilized as R¹, R², R³, and/or R⁴ independently can be a C₁ to C₂₀ alkyl group; alternatively, a C₁ to C₁₀ alkyl group; or alternatively, a C₁ to C₅ alkyl group. In an embodiment, each alkoxy group which can be utilized as R¹, R², R³, and/or R⁴ independently can be a C₁ to C₂₀ alkoxy group; alternatively, a C₁ to C₁₀ alkoxy group; or alternatively, a C₁ to C₅ alkoxy group. In an embodiment, each alkoxy group which can be utilized as R¹, R², R³, and/or R⁴ independently can be a C₁ to C₂₀ alkylthio group; alternatively, a C₁ to C₁₀ alkylthio group; or alternatively, a C₁ to C₅ alkylthio group.

In some embodiments, each non-hydrogen R¹, R², R³, and/or R⁴ independently can be an alkyl group, a substituted alkyl group, a cycloalkyl group, a substituted cycloalkyl group, an aryl group, a substituted aryl group, an aralkyl group, or a substituted aralkyl group. In other embodiments, each non-hydrogen R¹, R², R³, and/or R⁴ independently can be an alkyl group or a substituted alkyl group; alternatively, a cycloalkyl group or a substituted cycloalkyl group; alternatively, an aryl group or a substituted aryl group; or alternatively, a aralkyl group or a substitute aralkyl group. In yet other embodiments, each non-hydrogen R¹, R², R³, and/or R⁴ independently can be an alkyl group; alternatively, a substituted alkyl group; alternatively, a cycloalkyl group; alternatively, a substituted cycloalkyl group; alternatively, an aryl group; alternatively, a substituted aryl group; alternatively, an aralkyl group; or alternatively, a substituted aralkyl group. Generally, the alkyl group, substituted alkyl group, cycloalkyl group, substituted cycloalkyl group, aryl group, substituted aryl group, aralkyl group, and substituted aralkyl group which can be utilized as R can have the same number of carbon atoms as any organyl group or hydrocarbyl group of which it is a member.

In an embodiment, each non-hydrogen R¹, R², R³, and/or R⁴ independently a methyl group, an ethyl group, a propyl group, a butyl group, a pentyl group, a hexyl group, a heptyl group, an octyl group, a nonyl group, or a decyl group. In some embodiments, each non-hydrogen R¹, R², R³, and/or R⁴ independently can be a methyl group, an ethyl group, a n-propyl group, an iso-propyl group, a n-butyl group, an iso-butyl group, a sec-butyl group, a tert-butyl group, an n-pentyl group, an iso-pentyl group, a sec-pentyl group, or a neopentyl group; alternatively, a methyl group, an ethyl group, an iso-propyl group, a tert-butyl group, or a neopentyl group; alternatively, a methyl group; alternatively, an ethyl group; alternatively, a n-propyl group; alternatively, an iso-propyl group; alternatively, a tert-butyl group; or alternatively, a neopentyl group. In some embodiments, any of the disclosed alkyl groups can be substituted. Substituents for the substituted alkyl group are independently disclosed herein and can be utilized without limitation to further describe the substituted alkyl group which can be utilized as a non-hydrogen R¹, R², R³, and/or R⁴.

In an aspect, each cycloalkyl group (substituted or unsubstituted) which can be utilized as a non-hydrogen R¹, R², R³, and/or R⁴ independently can be a C₄ to C₂₀ cycloalkyl group (substituted or unsubstituted); alternatively, a C₅ to C₁₅ cycloalkyl group (substituted or unsubstituted); or alternatively, a C₅ to C₁₀ cycloalkyl group (substituted or unsubstituted). In an embodiment, each non-hydrogen R¹, R², R³, and/or R⁴ independently can be a cyclobutyl group, a substituted cyclobutyl group, a cyclopentyl group, a substituted cyclopentyl group, a cyclohexyl group, a substituted cyclohexyl group, a cycloheptyl group, a substituted cycloheptyl group, a cyclooctyl group, or a substituted cyclooctyl group. In other embodiments, each non-hydrogen R¹, R², R³, and/or R⁴ independently can be a cyclopentyl group, a substituted cyclopentyl group, a cyclohexyl group, or a substituted cyclohexyl group; alternatively, a cyclopentyl group or a substituted cyclopentyl group; or alternatively, a cyclohexyl group or a substituted cyclohexyl group. In further embodiments, each non-hydrogen R¹, R², R³, and/or R⁴ independently can be a cyclopentyl group; alternatively, a substituted cyclopentyl group; a cyclohexyl group; or alternatively, a substituted cyclohexyl group. Substituents for the substituted cycloalkyl group are independently disclosed herein and can be utilized without limitation to further describe the substituted cycloalkyl group which can be utilized as a non-hydrogen R group. Substituents for the substituted cycloalkyl groups (general or specific) are independently disclosed herein and can be utilized without limitation to further describe the substituted cycloalkyl groups which can be utilized as a non-hydrogen R¹, R², R³, and/or R⁴.

In an aspect, the aryl group (substituted or unsubstituted) which can be utilized as a non-hydrogen R¹, R², R³, and/or R⁴ independently can be a C₆-C₂₀ aryl group (substituted or unsubstituted); alternatively, a C₆-C₁₅ aryl group (substituted or unsubstituted); or alternatively, a C₆-C₁₀ aryl group (substituted or unsubstituted). In an embodiment, each R¹, R², R³, and/or R⁴ independently can be a phenyl group, a substituted phenyl group, a naphthyl group, or a substituted naphthyl group. In an embodiment, each R¹, R², R³, and/or R⁴ independently can be a phenyl group or a substituted phenyl group; alternatively, a naphthyl group or a substituted naphthyl group; alternatively, a phenyl group or a naphthyl group; or alternatively, a substituted phenyl group or a substituted naphthyl group.

In an embodiment, each substituted phenyl group which can be utilized as a non-hydrogen R¹, R², R³, and/or R⁴ independently can be a 2-substituted phenyl group, a 3-substituted phenyl group, a 4-substituted phenyl group, a 2,4-disubstituted phenyl group, a 2,6-disubstituted phenyl group, a 3,5-disubstituted phenyl group, or a 2,4,6-trisubstituted phenyl group. In other embodiments, each substituted phenyl group which can be utilized as a non-hydrogen R¹, R², R³, and/or R⁴ independently can be a 2-substituted phenyl group, a 4-substituted phenyl group, a 2,4-disubstituted phenyl group, or a 2,6-disubstituted phenyl group; alternatively, a 3-subsituted phenyl group or a 3,5-disubstituted phenyl group; alternatively, a 2-substituted phenyl group or a 4-substituted phenyl group; alternatively, a 2,4-disubstituted phenyl group or a 2,6-disubstituted phenyl group; alternatively, a 2-substituted phenyl group; alternatively, a 3-substituted phenyl group; alternatively, a 4-substituted phenyl group; alternatively, a 2,4-disubstituted phenyl group; alternatively, a 2,6-disubstituted phenyl group; alternatively, 3,5-disubstituted phenyl group; or alternatively, a 2,4,6-trisubstituted phenyl group. Substituents for the substituted phenyl groups (general or specific) are independently disclosed herein and can be utilized without limitation to further describe the substituted phenyl groups which can be utilized as a non-hydrogen R¹, R², R³, and/or R⁴.

Nonlimiting examples of suitable poly(arylene sulfide) polymers suitable for use in this disclosure include poly(2,4-toluene sulfide), poly(4,4′-biphenylene sulfide), poly(para-phenylene sulfide), poly(ortho-phenylene sulfide), poly(meta-phenylene sulfide), poly(xylene sulfide), poly(ethylisopropylphenylene sulfide), poly(tetramethylphenylene sulfide), poly(butylcyclohexylphenylene sulfide), poly(hexyldodecylphenylene sulfide), poly(octadecyl-phenylene sulfide), poly(phenylphenylene sulfide), poly(tolylphenylene sulfide), poly(benzyl-phenylene sulfide), poly[octyl-4-(3-methylcyclopentyl)phenylene sulfide], and any combination thereof.

In an embodiment the poly(arylene sulfide) polymer comprises poly(phenylene sulfide) or PPS. In an aspect, PPS is a polymer comprising at least about 70, 80, 90, or 95 mole percent para-phenylene sulfide units. In another embodiment, the poly(arylene sulfide) can contain up to about 50, 70, 80, 90, 95, or 99 mole percent para-phenylene sulfide units. In some embodiments, PPS can contain from any minimum mole percent of the para-phenylene sulfide unit disclosed herein to any maximum mole percent of the para-phenylene sulfide unit disclosed herein; for example, from about 70 to about 99 mole percent, alternatively, from about 70 to about 95 mole percent, or alternatively, from about 80 to about 95 mole percent of the —(Ar—S)— unit. Other suitable ranges for the para-phenylene sulfide units will be readily apparent to one of skill in the art with the help of this disclosure. The structure for the para-phenylene sulfide unit can be represented by Formula II.

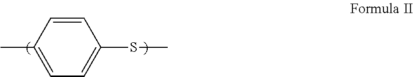

In an embodiment, PPS can comprise up to about 30, 20, 10, or 5 mole percent of one or more units selected from ortho-phenylene sulfide groups, meta-phenylene sulfide groups, substituted phenylene sulfide groups, phenylene sulfone groups, substituted phenylene sulfide groups, or groups having the following structures:

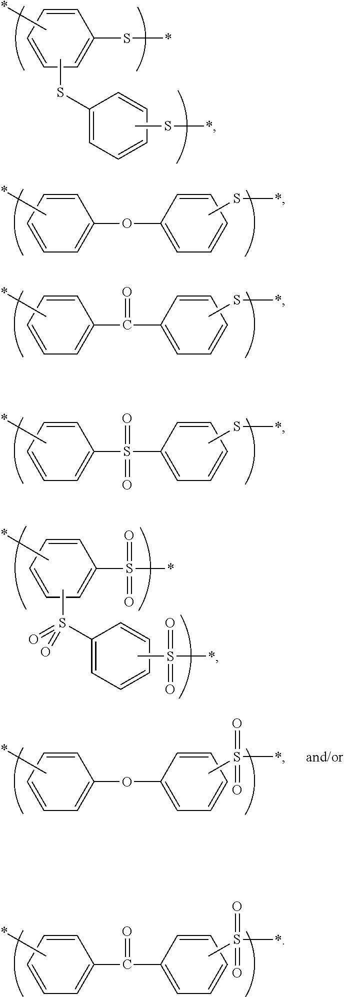

In other embodiments, PPS can comprise up to about 30, 20, 10, or 5 mole percent of units having one or more of the following structures:

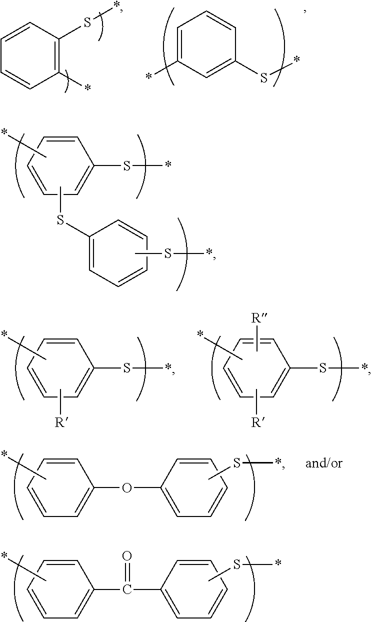

wherein R′ and R″ can be independently selected from any arylene substituent group disclosed herein for a poly(arylene sulfide). In other embodiments, PPS can comprise up to about 30, 20, 10, or 5 mole percent of units having one or more of the following structures:

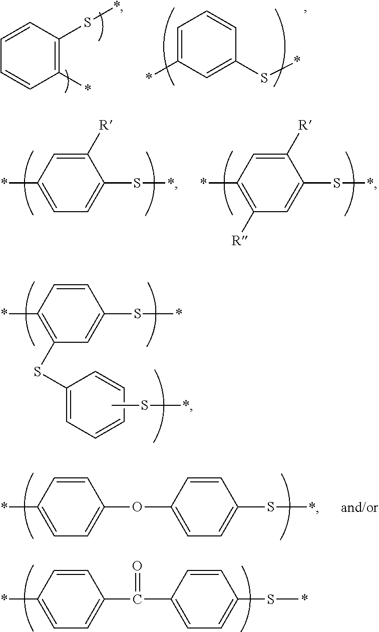

wherein R′ and R″ can be independently selected from any arylene substituent group disclosed herein for a poly(arylene sulfide). In other embodiments, PPS can comprise up to about 30, 20, 10, or 5 mole percent of units having one or more of the following structures:

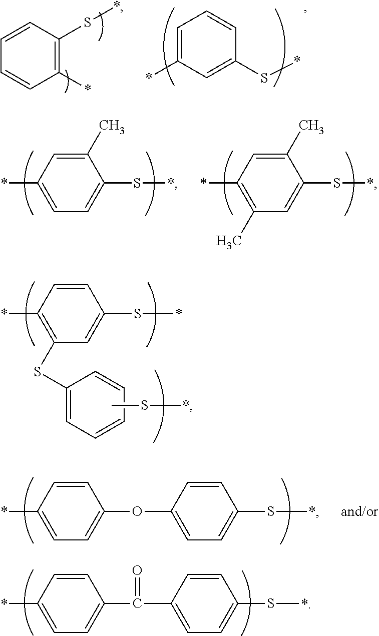

The PPS molecular structure can readily form a thermally stable crystalline lattice, giving PPS a semi-crystalline morphology with a high crystalline melting point ranging from about 265° C. to about 315° C. Because of its molecular structure, PPS also can tend to char during combustion, making the material inherently flame resistant. Further, PPS can not typically dissolve in solvents at temperatures below about 200° C.

PPS is manufactured and sold under the trade name Ryton® PPS by Chevron Phillips Chemical Company LP of The Woodlands, Tex. Other sources of poly(phenylene sulfide) include Ticona, Toray, and Dainippon Ink and Chemicals, Incorporated, among others.

Generally, a poly(arylene sulfide) can be produced by contacting at least one halogenated aromatic compound having two halogens, a sulfur compound, and a polar organic compound to form the poly(arylene sulfide). In an embodiment, the process to produce the poly(arylene sulfide) can further comprise recovering the poly(arylene sulfide). In some embodiments, the polyarylene sulfide can be formed under polymerization conditions capable of producing the poly(arylene sulfide). In an embodiment, the poly(arylene sulfide) can be produced in the presence of a halogenated aromatic compound having greater than two halogen atoms (e.g., 1,2,4,-trichlorobenzene, among others).

Similarly, PPS can be produced by contacting at least one para-dihalobenzene compound, a sulfur compound, and a polar organic compound to form the PPS. In an embodiment, the process to produce the PPS can further comprise recovering the PPS. In some embodiments, the PPS can be formed under polymerization conditions capable of forming the PPS. When producing PPS, other dihaloaromatic compounds can also be present so long as the produced PPS conforms to the PPS desired features. For example, in an embodiment, the PPS can be prepared utilizing substituted para-dihalobenzene compounds and/or halogenated aromatic compounds having greater than two halogen atoms (e.g., 1,2,4-trichlorobenzene or substituted or a substituted 1,2,4-trichlorobenzene, among others). Methods of PPS production are described in more detail in U.S. Pat. Nos. 3,919,177; 3,354,129; 4,038,261; 4,038,262; 4,038,263; 4,064,114; 4,116,947; 4,282,347; 4,350,810; and 4,808,694; each of which is incorporated by reference herein in its entirety.

In an embodiment, halogenated aromatic compounds having two halogens which can be employed to produce the poly(arylene sulfide) can be represented by Formula III.

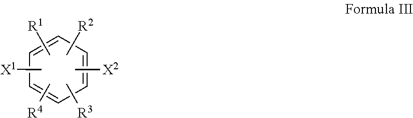

In an embodiment, X¹ and X² independently can be a halogen. In some embodiments, each X¹ and X² independently can be fluorine, chlorine, bromine, iodine; alternatively, chlorine, bromine, or iodine; alternatively, chlorine; alternatively, bromine; or alternatively, iodine. R¹, R², R³, and R⁴ have been described previously herein for the poly(arylene sulfide) having Formula I. Any aspect and/or embodiment of these R¹, R², R³, and R⁴ descriptions can be utilized without limitation to describe the halogenated aromatic compounds having two halogens represented by Formula III. It should be understood, that for producing poly(arylene sulfide)s, the relationship between the position of the halogens X¹ and X² can be ortho, meta, para, or any combination thereof; alternatively, ortho; alternatively, meta; or alternatively, para. Examples of halogenated aromatic compounds having two halogens that can be utilized to produce a poly(arylene sulfide) can include, but not limited to, dichlorobenzene (ortho, meta, and/or para), dibromobenzene (ortho, meta, and/or para), diiodobenzene (ortho, meta, and/or para), chlorobromobenzene (ortho, meta, and/or para), chloroiodobenzene (ortho, meta, and/or para), bromoiodobenzene (ortho, meta, and/or para), dichlorotoluene, dichloroxylene, ethylisopropyldibromobenzene, tetramethyldichlorobenzene, butylcyclohexyldibromobenzene, hexyldodecyldichlorobenzene, octadecyldiidobenzene, phenylchlorobromobenzene, tolyldibromobenzene, benzyldichloro-benzene, octylmethylcyclopentyldichlorobenzene, or any combination thereof.

The para-dihalobenzene compound which can be utilized to produce poly(phenylene sulfide) can be any para-dihalobenzene compound. In an embodiment, para-dihalobenzenes that can be used in the synthesis of PPS can be, comprise, or consist essentially of, p-dichlorobenzene, p-dibromobenzene, p-diiodobenzene, 1-chloro-4-bromobenzene, 1-chloro-4-iodobenzene, 1-bromo-4-iodobenzene, or any combination thereof. In some embodiments, the para-dihalobenzene that can be used in the synthesis of PPS can be, comprise, or consist essentially of, p-dichlorobenzene.

In some embodiments, the synthesis of the PPS can further include 2,5-dichlorotoluene, 2,5 -dichloro-p-xylene, 1-ethyl-4-isopropyl-2,5-dibromobenzene, 1,2,4,5-tetramethyl-3,6-dichlorobenzene, 1-butyl-4-cyclohexyl-2,5-dibromobenzene, 1-hexyl-3-dodecyl-2,5-dichlorobenzene, 1-octadecyl-2,5-diidobenzene, 1-phenyl-2-chloro-5-bromobenzene, 1-(p-tolyl)-2,5-dibromobenzene, 1-benzyl-2,5-dichlorobenzene, 1-octyl-4-(3-methylcyclopentyl)-2,5-dichlorobenzene, or combinations thereof.

Without wishing to be limited by theory, sulfur sources which can be employed in the synthesis of the poly(arylene sulfide) can include thiosulfates, thioureas, thioamides, elemental sulfur, thiocarbamates, metal disulfides and oxysulfides, thiocarbonates, organic mercaptans, organic mercaptides, organic sulfides, alkali metal sulfides and bisulfides, hydrogen sulfide, or any combination thereof. In an embodiment, an alkali metal sulfide can be used as the sulfur source. Alkali metal sulfides suitable for use in the present disclosure can be, comprise, or consist essentially of, lithium sulfide, sodium sulfide, potassium sulfide, rubidium sulfide, cesium sulfide, or any combination thereof. In some embodiments, the alkali metal sulfides that can be employed in the synthesis of the poly(arylene sulfide) can be an alkali metal sulfide hydrate or an aqueous alkali metal sulfide solution; alternatively, an alkali metal sulfide hydrate; or alternatively, an aqueous alkali metal sulfide solution. Aqueous alkali metal sulfide solution can be prepared by any suitable methodology. In an embodiment, the aqueous alkali metal sulfide solution can be prepared by the reaction of an alkali metal hydroxide with an alkali metal bisulfide in water; or alternatively, prepared by the reaction of an alkali metal hydroxide with hydrogen sulfide (H₂S) in water. Other sulfur sources suitable for use in the present disclosure are described in more detail in U.S. Pat. No. 3,919,177, which is incorporated by reference herein in its entirety.

In an embodiment, a process for the preparation of poly(arylene sulfide) can utilize a sulfur source which can be, comprise, or consist essentially of, an alkali metal bisulfide. In such embodiments, a reaction mixture for preparation of the poly(arylene sulfide) can comprise a base. In such embodiments, alkali metal hydroxides, such as sodium hydroxide (NaOH) can be utilized. In such embodiments, it can be desirable to reduce the alkalinity of the reaction mixture prior to termination of the polymerization reaction. Without wishing to be limited by theory, a reduction in alkalinity of the reaction mixture can result in the formation of a reduced amount of ash-causing polymer structures. The alkalinity of the reaction mixture can be reduced by any suitable methodology, for example by the addition of an acidic solution prior to termination of the polymerization reaction.

In an embodiment, the sulfur source suitable for use in the production of poly(arylene sulfide) can be prepared by combining sodium hydrosulfide (NaSH) and sodium hydroxide (NaOH) in an aqueous solution followed by dehydration (or alternatively, by combining an alkali metal hydroxide with hydrogen sulfide (H₂S)). The production of Na₂S in this manner can be considered to be an equilibrium between Na₂S, water (H₂O), NaSH, and NaOH according to the following equation.

Na₂S+H₂O [symbol] NaSH+NaOH

The resulting sulfur source can be referred to as sodium sulfide (Na₂S). In another embodiment, the production of Na₂S can be performed in the presence of the polar organic solvent, e.g., N-methyl-2-pyrrolidone (NMP), among others disclosed herein. Without being limited to theory, when the sulfur compound (e.g., sodium sulfide) is prepared by reacting NaSH with NaOH in the presence of water and N-methyl-2-pyrrolidone, the N-methyl-2-pyrrolidone can also react with the sodium hydroxide (e.g., aqueous sodium hydroxide) to produce a mixture containing sodium hydrosulfide and sodium N-methyl-4-aminobutanoate (SMAB). Stoichiometrically, the overall reaction equilibrium can appear to follow the equation:

NMP+Na₂S+H₂O [symbol] CH₃NH₂CH₂CH₂CH₂CO₂Na (SMAB)+NaSH

However, it should be noted that this equation is a simplification and, in actuality, the equilibrium between Na₂S, H₂O, NaOH, and NaSH, and the water-mediated ring opening of NMP by sodium hydroxide can be significantly more complex.

The polar organic compound which can be utilized in the preparation of a poly(arylene sulfide) can comprise a polar organic compound which can function to keep the dihaloaromatic compounds, sulfur source, and growing poly(arylene sulfide) in solution during the polymerization. In an aspect, the polar organic compound can be, comprise, or consist essentially of, an amide, a lactam, a sulfone, or any combinations thereof; alternatively, an amide; alternatively, a lactam; or alternatively, a sulfone. In an embodiment, the polar organic compound can be, comprise, or consist essentially of, hexamethylphosphoramide, tetramethylurea, N,N′-ethylenedipyrrolidone, N-methyl-2-pyrrolidone, pyrrolidone, caprolactam, N-ethylcaprolactam, sulfolane, N,N′-dimethylacetamide, 1,3-dimethyl-2-imidazolidinone, low molecular weight polyamides, or combinations thereof. In an embodiment, the polar organic compound can be, comprise, or consist essentially of, N-methyl-2-pyrrolidone. Additional polar organic compounds suitable for use in the present disclosure are described in more detail in D. R. Fahey and J. F. Geibel, Polymeric Materials Encyclopedia, Vol. 8, (Boca Raton, CRC Press, 1996), pages 6506-6515, which is incorporated by reference herein in its entirety.

In an embodiment, processes for the preparation of a poly(arylene sulfide) can employ one or more additional reagents. For example, molecular weight modifying or enhancing agents such as alkali metal carboxylates, lithium halides, or water can be added or produced during polymerization. In an embodiment, a reaction mixture for preparation of a poly(arylene sulfide) can further comprise an alkali metal carboxylate.

Alkali metal carboxylates which can be employed include, without limitation, those having general formula R′CO₂M where R′ can be a C₁ to C₂₀ hydrocarbyl group, a C₁ to C₂₀ hydrocarbyl group, or a C₁ to C₅ hydrocarbyl group. In some embodiments, R′ can be an alkyl group, a cycloalkyl group, an aryl group, aralkyl group; or alternatively, an alkyl group. Alkyl groups, cycloalkyl groups, aryl groups, aralkyl groups are disclosed herein (e.g., as options for R¹, R², R³, and R⁴ or a substituent groups). These alkyl groups, cycloalkyl groups, aryl groups, aralkyl groups can be utilized without limitation to further describe R′ of the alkali metal carboxylates having the formula R′CO₂M. In an embodiment, M can be an alkali metal. In some embodiments, the alkali metal can be, comprise, or consist essentially of, lithium, sodium, potassium, rubidium, or cesium; alternatively, lithium; alternatively, sodium; or alternatively, potassium. The alkali metal carboxylate can be employed as a hydrate; or alternatively, as a solution or dispersion in water. In an embodiment, the alkali metal carboxylate can be, comprise, or consist essentially of, sodium acetate (NaOAc or NaC₂H₃O₂).

General conditions for the production of poly(arylene sulfides) are generally described in U.S. Pat. Nos. 5,023,315; 5,245,000; 5,438,115; and 5,929,203; each of which is incorporated by reference herein in its entirety. Although specific mention can be made in this disclosure and the disclosures incorporated by reference herein to material produced using the “quench” termination process, it is contemplated that other processes (e.g., “flash” termination process) can be employed for the preparation of a poly(arylene sulfide) (e.g., PPS). It is contemplated that a poly(arylene sulfide) obtained from a process other than the quench termination process can be suitably employed in the methods and compositions of this disclosure.

Generally, the ratio of reactants employed in the polymerization process to produce a poly(arylene sulfide) can vary widely. However, the typical equivalent ratio of the halogenated aromatic compound having two halogens to sulfur compound can be in the range of from about 0.8 to about 2; alternatively, from about 0.9 to about 1.5; or alternatively, from about 0.95 to about 1.3. The amount of polyhalo-substituted aromatic compound optionally employed as a reactant can be any amount to achieve the desired degree of branching to give the desired poly(arylene sulfide) melt flow. Generally, up to about 0.02 moles of polyhalo-substituted aromatic compound per mole of halogenated aromatic compound having two halogens can be employed. If an alkali metal carboxylate is employed as a molecular weight modifying agent, the mole ratio of alkali metal carboxylate to dihaloaromatic compound(s) can be within the range of from about 0.02 to about 4; alternatively, from about 0.05 to about 3; or alternatively, from about 0.1 to about 2.

The amount of polar organic compound employed in the process to prepare the poly(arylene sulfide) can vary over a wide range during the polymerization. However, the molar ratio of polar organic compound to the sulfur compound is typically within the range of from about 1 to about 10. If a base, such as sodium hydroxide, is contacted with the polymerization reaction mixture, the molar ratio is generally in the range of from about 0.5 to about 4 moles per mole of sulfur compound.

The components of the reaction mixture can be contacted with each other in any order. Some of the water, which can be introduced with the reactants, can be removed prior to polymerization. In some instances, the water can be removed in a dehydration process. For example, in instances where a significant amount of water is present (e.g., more than about 0.3 moles of water per mole of sulfur compound) water can be removed in a dehydration process. The temperature at which the polymerization can be conducted can be within the range of from about 170° C. (347° F.) to about 450° C. (617° F.); or alternatively, within the range of from about 200° C. (392° F.) to about 285° C. (545° F.). The reaction time can vary widely, depending, in part, on the reaction temperature, but is generally within the range of from about 10 minutes to about 3 days; or alternatively, within a range of from about 1 hour to about 8 hours. The reactor pressure need be only sufficient to maintain the polymerization reaction mixture substantially in the liquid phase. Such pressure will can be in the range of from about 0 psig to about 400 psig; alternatively, in the range of from about 30 psig to about 300 psig; or alternatively, in the range of from about 100 psig to about 250 psig.

The polymerization can be terminated by cooling the reaction mixture (removing heat) to a temperature below that at which substantial polymerization takes place. In some instances the cooling of the reaction mixture also begins the process to recover the poly(arylene sulfide) as the poly(arylene sulfide) can precipitate from solution at temperatures less than about 235° C. Depending upon the polymerization features (temperature, solvent(s), and water quantity, among other features) and the methods employed to cool the reaction mixture, the poly(arylene sulfide) can begin to precipitate from the reaction solution at a temperature ranging from about 235° C. to about 185° C. Generally, poly(arylene sulfide) precipitation can impede further polymerization.

The poly(arylene sulfide) reaction mixture can be cooled using a variety of methods. In an embodiment, the polymerization can be terminated by the flash evaporation of the solvent (e.g., the polar organic compound, water, or a combination thereof) from the poly(arylene sulfide) reaction mixture. Processes for preparing poly(arylene sulfide) utilizing solvent flash evaporation to terminate the reaction can be referred to as a flash termination process. In other embodiments, the polymerization can be terminated by adding a liquid comprising, or consisting essentially of, 1) water, 2) polar organic compound, or 3) a combination of water and polar organic compound (alternatively, water; or alternatively, polar organic compound) to the poly(arylene sulfide) reaction mixture and cooling the poly(arylene sulfide) reaction mixture. In yet other embodiments, the polymerization can be terminated by a solvent(s) other than water or the polar organic compound to the poly(arylene sulfide) reaction mixture and cooling the poly(arylene sulfide) reaction mixture. Processes for preparing poly(arylene sulfide) which utilize the addition of water, polar organic compound, and/or other solvent(s) to terminate the reaction can be referred to as a quench termination process. The cooling of the reaction mixture can be facilitated by the use of reactor jackets or coil. Another method for terminating the polymerization can include contacting the reaction mixture with a polymerization inhibiting compound. It should be noted that termination of the polymerization does not imply that complete reaction of the polymerization components has occurred. Moreover, termination of the polymerization is not meant to imply that no further polymerization of the reactants can take place. Generally, for economic reasons, termination (and poly(arylene sulfide) recovery) can be initiated at a time when polymerization is substantially complete or when further reaction would not result in a significant increase in polymer molecular weight.

Once the poly(arylene sulfide) has precipitated from solution, particulate poly(arylene sulfide) or poly(arylene sulfide) polymer particles (e.g., PPS polymer particles) can be recovered from the reaction mixture slurry by any process capable of separating a solid particulate from a liquid. For the purposes of the disclosure herein the recovered particulate poly(arylene sulfide) (e.g., recovered poly(arylene sulfide) polymer particles) will be referred to as “raw poly(arylene sulfide) polymer particle(s),” “raw poly(arylene sulfide) particle(s),” “raw poly(arylene sulfide) polymer,” or simply “raw poly(arylene sulfide),” (e.g., “raw PPS”). It should be noted that the process to produce the poly(arylene sulfide) can form a by-product alkali metal halide. The by-product alkali metal halide can be removed during process steps utilized to recover the raw poly(arylene sulfide) (e.g., raw PPS). Procedures which can be utilized to recover the raw poly(arylene sulfide) polymer particles from the reaction mixture slurry can include, but are not limited to, i) filtration, ii) washing the raw poly(arylene sulfide) with a liquid (e.g., water or aqueous solution), or iii) dilution of the reaction mixture with liquid (e.g., water or aqueous solution) followed by filtration and washing the raw poly(arylene sulfide) with a liquid (e.g., water or aqueous solution). For example, in a non-limiting embodiment, the reaction mixture slurry can be filtered to recover the raw poly(arylene sulfide) (e.g., the raw PPS) polymer particles (containing poly(arylene sulfide) or PPS, and by-product alkali metal halide), which can be slurried in a liquid (e.g., water or aqueous solution) and subsequently filtered to remove the alkali metal halide by-product (and/or other liquid, e.g., water, soluble impurities). Generally, the steps of slurrying the raw poly(arylene sulfide) with a liquid followed by filtration to recover the raw poly(arylene sulfide) can occur as many times as necessary to obtain a desired level of purity of the raw poly(arylene sulfide).

In an embodiment, the polar organic compound can also be recovered at the end of the polymerization process. For example, if the raw poly(arylene sulfide) is being recovered by filtration, the filtrate (e.g., the liquid phase in the filtration process) can comprise the polar organic compound. Such filtrate can be subjected to a liquid-liquid extraction process for the recovery of the polar organic compound. For example, when the polar organic compound is NMP, the filtrate can be treated with an alcohol (e.g., 1-hexanol), and the NMP can be recovered in the phase comprising the alcohol (e.g., 1-hexanol). The recovered NMP can be recycled/reused in a subsequent polymerization process for the production of poly(arylene sulfide) (e.g., PPS).

The raw poly(arylene sulfide) polymer particles can undergo post recovery processing, e.g., a treatment to improve the melt properties of the poly(arylene sulfide) polymer. In an embodiment, the raw poly(arylene sulfide) can be dried to remove liquid adhering to the raw poly(arylene sulfide) (e.g., PPS) polymer particles. Generally, the raw poly(arylene sulfide) which can undergo post recovery processing can be i) the raw poly(arylene sulfide) recovered from the reaction mixture or ii) the raw poly(arylene sulfide) (e.g., raw PPS) which has been washed with a liquid (e.g., water) and filtered to remove the alkali metal halide by-product (and/or other liquid soluble impurities). The raw poly(arylene sulfide) which can undergo post recovery processing can either be liquid wet or dry; alternatively, liquid wet; or alternatively, dry.

In an embodiment, the raw poly(arylene sulfide) polymer particles can undergo one or more steps to distinguish small poly(arylene sulfide) particles from large poly(arylene sulfide) particles prior to, concurrent with, and/or subsequent to treatment to improve the melt properties of the poly(arylene sulfide) polymer. As used herein, particle size (e.g., poly(arylene sulfide) polymer particle size) is determined in accordance with the ability of a polymer particle to pass through a woven wire test sieve as described in ASTM E11-09. For purposes of this disclosure, all references to a woven wire test sieve refer to a woven wire test sieve as described in ASTM E11-09. As used herein, reference to particle size (e.g., poly(arylene sulfide) polymer particle size) refers to the size of an aperture (e.g., nominal aperture dimension) through which the polymer particle (e.g., poly(arylene sulfide) polymer particle) will pass, and for brevity this is referred to herein as “particle size.” An aperture is an opening in a sieve (e.g., woven wire test sieve) or a screen for particles to pass through. The aperture of the woven wire test sieve is a square and the nominal aperture dimension refers to the width of the square aperture. For purposes of this disclosure, all references to the ability of a polymer particle (e.g., poly(arylene sulfide) polymer particle) to pass through a woven wire test sieve refer to the ability of a polymer particle to pass through a woven wire test sieve as measured in accordance with ASTM D1921-12. For example, a polymer particle (e.g., a poly(arylene sulfide) polymer particle) is considered to have a size of less than about 2.00 mm if the polymer particle passes through the aperture of a 10 mesh woven wire test sieve, where the mesh size is given based on U.S. Sieve Series. As will be appreciated by one of skill in the art, and with the help of this disclosure, poly(arylene sulfide) polymer particles can have a plurality of shapes, such as for example cylindrical, discoidal, spherical, tabular, ellipsoidal, equant, irregular, or combinations thereof. Generally, for a particle to pass through an aperture of a sieve or screen, it is not necessary for all dimensions of the particle to be smaller than the aperture of such screen or sieve, and it could be enough for one of the dimensions of the particle to be smaller than the aperture of such screen or sieve. For example, if a cylindrical shaped particle that has a diameter of 1.00 mm and a length of 2.50 mm passes through the aperture of a 10 mesh woven wire test sieve, where the mesh size is according to U.S. Sieve Series, such particle is considered to have a particle size of less than about 2.00 mm. As used herein, mesh sizes corresponding to particular sieves (e.g., woven wire test sieves) are according to U.S. Sieves Series, and the nominal aperture dimensions of the woven wire test sieves are as outlined in Table 1:

TABLE 1

| Mesh Size | Nominal Aperture Dimension [mm] |
|---|---|
| 6 | 3.35 |
| 8 | 2.38 |
| 10 | 2.00 |
| 12 | 1.68 |
| 14 | 1.40 |
| 16 | 1.20 |

For purposes of the disclosure herein poly(arylene sulfide) polymer particles having a particle size of less than about 2.38 mm refer to the poly(arylene sulfide) polymer particles that will pass through an 8 mesh (i.e., 2.38 mm, based on U.S. Sieve Series) woven wire test sieve as measured in accordance with ASTM D1921-12, and such poly(arylene sulfide) polymer particles are referred to as “small poly(arylene sulfide) polymer particles” or “small poly(arylene sulfide) particles.” Further, for purposes of the disclosure herein poly(arylene sulfide) polymer particles having a particle size of equal to or greater than about 2.38 mm refer to the poly(arylene sulfide) polymer particles that will not pass through an 8 mesh (i.e., 2.38 mm, based on U.S. Sieve Series) woven wire test sieve as measured in accordance with ASTM D1921-12, and such poly(arylene sulfide) polymer particles are referred to as “large poly(arylene sulfide) polymer particles” or “large poly(arylene sulfide) particles.”

In an embodiment, the poly(arylene sulfide) polymer comprises a plurality of small poly(arylene sulfide) polymer particles and large poly(arylene sulfide) polymer particles. In such embodiment, the poly(arylene sulfide) polymer can be characterized with reference to the amount of material that will pass through a particular sieve (e.g., woven wire test sieve) when measured in accordance with ASTM D1921-12, e.g., Dw10, Dw50, Dw90, etc. The Dw50 refers to 50 wt. % of the total polymer particle population having sizes at or below an indicated value, while the other 50 wt. % of the total polymer particle population has sizes above the indicated value. The Dw10 and Dw90 refer to the cumulative undersize distribution which notes the percentage weight of polymer particles (i.e., 10 wt. % or 90 wt. %) having sizes at or below the indicated value. The Dw10, Dw50, Dw90 can be determined by standard particle size measurements, such as physically sifting the material (e.g., sifting through a woven wire test sieve) in accordance with ASTM D1921-12 and measuring the mass of each fraction and calculating that fraction as a percentage of the total. For example, if 90 wt. % of the poly(arylene sulfide) polymer particles have a particle size of less than about 2.38 mm (e.g., 90 wt. % small poly(arylene sulfide) polymer particles), and 10 wt. % of the poly(arylene sulfide) polymer particles have a particle size of equal to or greater than about 2.38 mm (e.g., 10 wt. % large poly(arylene sulfide) polymer particles), then the poly(arylene sulfide) polymer particles have a Dw90 of about 2.38 mm. As will be appreciated by one of skill in the art, and with the help of this disclosure, it is not necessary to sift/test the entire amount of polymer (e.g., poly(arylene sulfide) polymer) for determining its particle size distribution; it is usually sufficient to use at least one representative sample of the polymer (e.g., poly(arylene sulfide) polymer), such as for example a sample of the polymer (e.g., poly(arylene sulfide) polymer) that has about the same particle size distribution as the entire amount of polymer (e.g., poly(arylene sulfide) polymer).

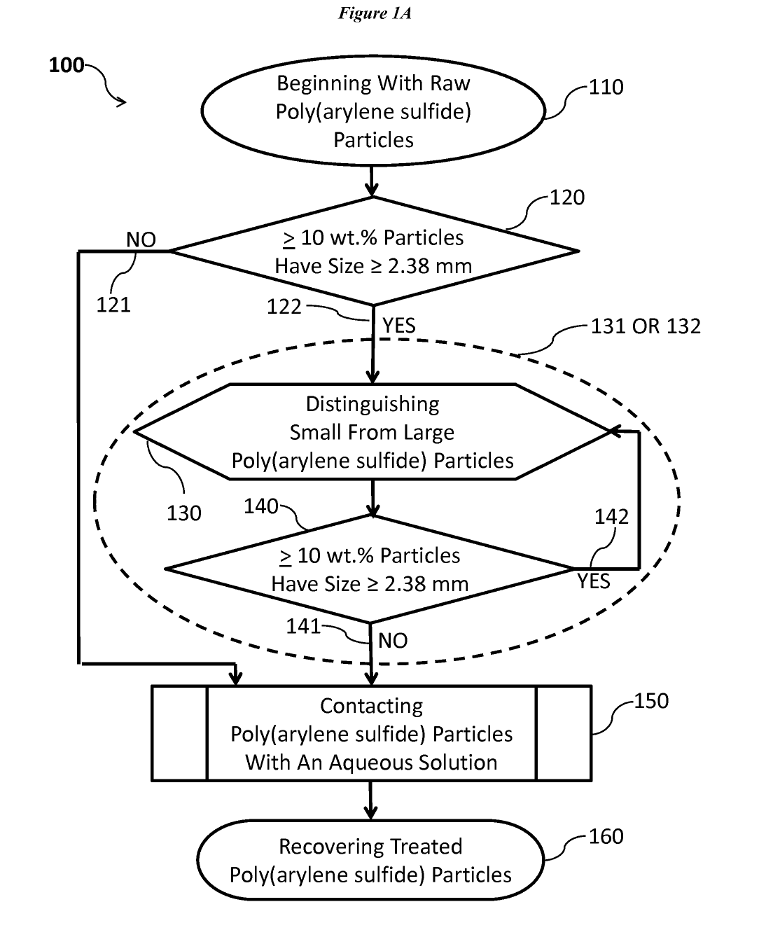

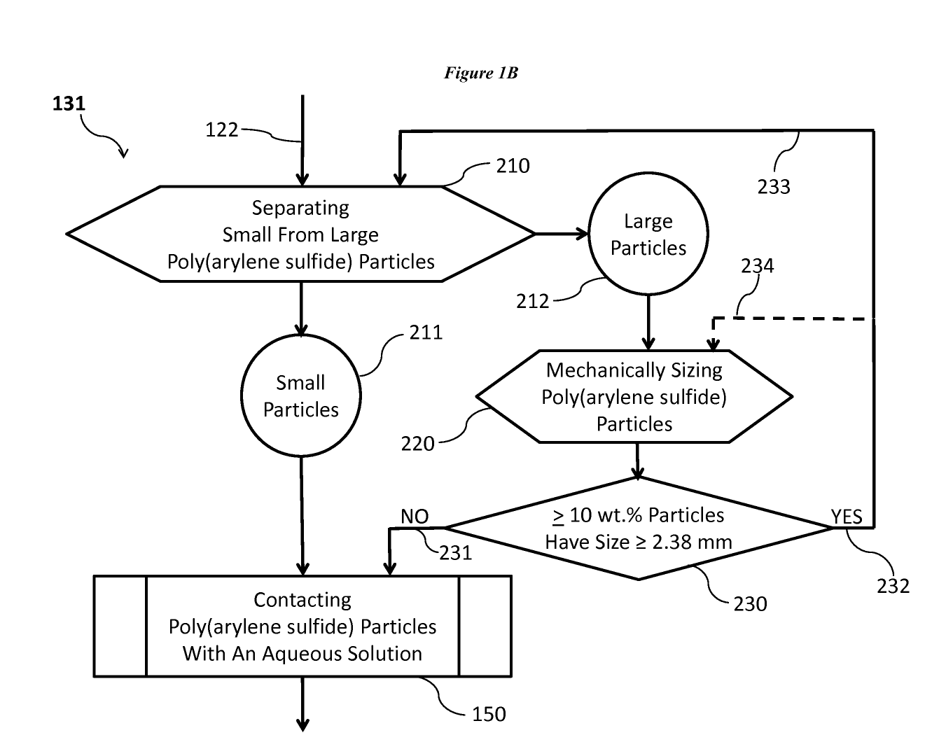

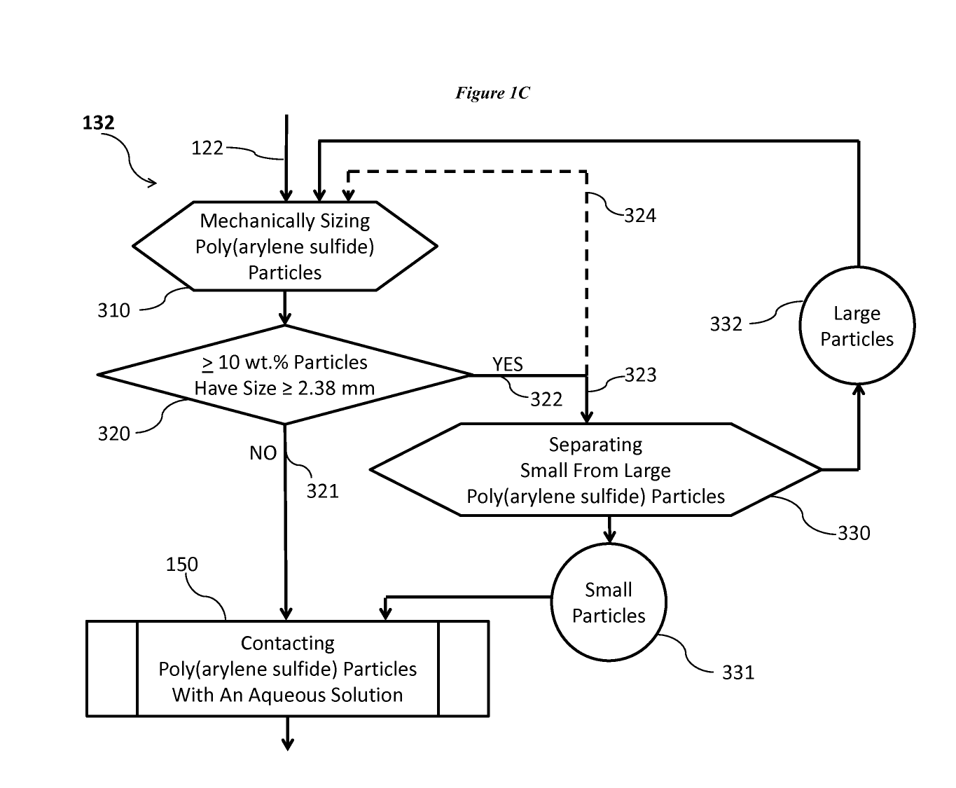

In an embodiment, the raw poly(arylene sulfide) polymer can undergo one or more steps to distinguish small poly(arylene sulfide) particles from large poly(arylene sulfide) particles. Referring to FIG. 1A, an embodiment of a process 100 to distinguish small poly(arylene sulfide) particles from large poly(arylene sulfide) particles is depicted. In the embodiment of FIG. 1A, the process 100 to distinguish small poly(arylene sulfide) particles from large poly(arylene sulfide) particles generally comprises the steps of beginning with raw poly(arylene sulfide) particles 110; particle size distribution determination (e.g., screening of a sample) 120; distinguishing small poly(arylene sulfide) particles from large poly(arylene sulfide) particles 130; particle size distribution determination (e.g., screening of a sample) 140; contacting poly(arylene sulfide) particles with an aqueous solution 150; and recovering treated poly(arylene sulfide) particles 160.

Referring to the embodiment of FIG. 1A, beginning with raw poly(arylene sulfide) particles 110 for the distinguishing process 100 comprises beginning with (e.g., supplying, starting with, obtaining, providing, procuring, etc.) raw poly(arylene sulfide) polymer particles that have been prepared as previously described herein.

In an embodiment, the raw poly(arylene sulfide) polymer particles have a particle size distribution wherein the Dw90 is less than about 2.38 mm, alternatively less than about 1.68 mm, or alternatively less than about 1.20 mm.

In an embodiment, the raw poly(arylene sulfide) polymer particles comprise a poly(arylene sulfide) polymer particle size distribution having less than 10 wt. % poly(arylene sulfide) polymer particles having a particle size of equal to or greater than about 2.38 mm, alternatively less than 10 wt. % poly(arylene sulfide) polymer particles having a particle size of equal to or greater than about 1.68 mm, or alternatively less than 10 wt. % poly(arylene sulfide) polymer particles having a particle size of equal to or greater than about 1.20 mm.

In an embodiment, the raw poly(arylene sulfide) polymer particles comprise a poly(arylene sulfide) polymer particle size distribution having equal to or greater than 10 wt. % large poly(arylene sulfide) polymer particles (e.g., Dw90 is less than about 2.38 mm), alternatively, equal to or greater than 50 wt. % large poly(arylene sulfide) polymer particles (e.g., Dw50 is less than about 2.38 mm), or alternatively, equal to or greater than 90 wt. % large poly(arylene sulfide) polymer particles (e.g., Dw10 is less than about 2.38 mm), based on the total weight of the raw poly(arylene sulfide) polymer particles.

Referring to the embodiment of FIG. 1A, the raw poly(arylene sulfide) polymer particles are subjected to a step of particle size distribution determination (e.g., screening of a sample) 120. The particle size distribution determination (e.g., screening of a sample) 120 can be performed on at least a portion of the raw poly(arylene sulfide) polymer particles, as previously described herein. In an embodiment, if less than 10 wt. % of the raw poly(arylene sulfide) polymer particles have a particle size of equal to or greater than about 2.38 mm, at least a portion of the raw poly(arylene sulfide) polymer particles can be directed 121 to the step of contacting poly(arylene sulfide) particles with an aqueous solution 150. In an alternative embodiment, if equal to or greater than 10 wt. % of the raw poly(arylene sulfide) polymer particles have a particle size of equal to or greater than about 2.38 mm, at least a portion of the raw poly(arylene sulfide) polymer particles can be directed 122 to a step of distinguishing small poly(arylene sulfide) particles from large poly(arylene sulfide) particles 130, thereby yielding distinguished small poly(arylene sulfide) polymer particles.

Referring to the embodiment of FIG. 1A, the poly(arylene sulfide) polymer particles that are obtained from the step of distinguishing small poly(arylene sulfide) particles from large poly(arylene sulfide) particles 130 (e.g., distinguished poly(arylene sulfide) polymer particles, distinguished small poly(arylene sulfide) polymer particles, distinguished large poly(arylene sulfide) polymer particles) are subjected to a step of particle size distribution determination (e.g., screening of a sample) 140 (i.e., a second particle size distribution determination). The particle size distribution determination (e.g., screening of a sample) 140 can be performed on at least a portion of the distinguished poly(arylene sulfide) polymer particles (e.g., distinguished small poly(arylene sulfide) polymer particles, distinguished large poly(arylene sulfide) polymer particles), as previously described herein, to determine whether the distinguished poly(arylene sulfide) polymer particles are distinguished small poly(arylene sulfide) polymer particles, distinguished large poly(arylene sulfide) polymer particles, or a combination thereof. In an embodiment, if less than 10 wt. % of the distinguished poly(arylene sulfide) polymer particles (e.g., distinguished small poly(arylene sulfide) polymer particles) have a particle size of equal to or greater than about 2.38 mm, at least a portion of the distinguished poly(arylene sulfide) polymer particles (e.g., distinguished small poly(arylene sulfide) polymer particles) can be directed 141 to the step of contacting poly(arylene sulfide) particles with an aqueous solution 150. In an alternative embodiment, if equal to or greater than 10 wt. % of the distinguished poly(arylene sulfide) polymer particles (e.g., distinguished large poly(arylene sulfide) polymer particles) have a particle size of equal to or greater than about 2.38 mm, at least a portion of the distinguished poly(arylene sulfide) polymer particles (e.g., distinguished large poly(arylene sulfide) polymer particles) can be redirected 142 back to the step of distinguishing small poly(arylene sulfide) particles from large poly(arylene sulfide) particles 130.

In an embodiment, a piece of equipment or device can be designed (e.g., used) to accommodate both the step of distinguishing small poly(arylene sulfide) particles from large poly(arylene sulfide) particles 130 and the step of particle size distribution determination (e.g., screening of a sample) 140 (i.e., a second particle size distribution determination), such as for example a grinding machine equipped with a screen or sieve (e.g., woven wire test sieve) that would not allow particles (e.g., poly(arylene sulfide) particles) to pass through until the particles (e.g., poly(arylene sulfide) particles) would be reduced to a required size (e.g., less than about 2.38 mm).

Referring to FIG. 1A, in an embodiment, at least a portion of the raw poly(arylene sulfide) polymer particles directed 122 to a step of distinguishing small poly(arylene sulfide) particles from large poly(arylene sulfide) particles can be first subjected to a step of distinguishing by separation 131 as depicted in FIG. 1B. Referring to the embodiment of FIG. 1B, at least a portion of the raw poly(arylene sulfide) polymer particles are subjected to a step of separating small poly(arylene sulfide) particles from large poly(arylene sulfide) particles 210 (e.g., via screening, shakers, etc.), wherein a small poly(arylene sulfide) particles fraction 211 (e.g., distinguished or separated small poly(arylene sulfide) polymer particles) and a large poly(arylene sulfide) particles fraction 212 (e.g., distinguished or separated large poly(arylene sulfide) polymer particles) are obtained. At least a portion of the small poly(arylene sulfide) particles fraction 211 can be further subjected to the step of contacting poly(arylene sulfide) particles with an aqueous solution 150. At least a portion of the large poly(arylene sulfide) particles fraction 212 can be further subjected to a step of mechanically sizing or mechanically reducing the size of poly(arylene sulfide) particles 220 to yield mechanically sized poly(arylene sulfide) polymer particles, followed by a step of particle size distribution determination (e.g., screening of a sample) 230. The particle size distribution screening 230 can be performed on at least a portion of the mechanically sized poly(arylene sulfide) polymer particles, as previously described herein. In an embodiment, if less than 10 wt. % of the mechanically sized poly(arylene sulfide) polymer particles have a particle size of equal to or greater than about 2.38 mm, at least a portion of the mechanically sized poly(arylene sulfide) polymer particles can be directed 231 to the step of contacting poly(arylene sulfide) particles with an aqueous solution 150. In an alternative embodiment, if equal to or greater than 10 wt. % of the mechanically sized poly(arylene sulfide) polymer particles have a particle size of equal to or greater than about 2.38 mm, at least a portion of the mechanically sized poly(arylene sulfide) polymer particles can be redirected 232 either (i) via path 233 back to the step of separating small poly(arylene sulfide) particles from large poly(arylene sulfide) particles 210 or (ii) via path 234 back to the step of mechanically sizing poly(arylene sulfide) particles 220.

In an embodiment, a piece of equipment or device can be designed (e.g., used) to accommodate both the step of mechanically sizing poly(arylene sulfide) particles 220 and the step of particle size distribution determination (e.g., screening of a sample) 230, such as for example a grinding machine equipped with a screen or sieve (e.g., woven wire test sieve) that would not allow particles (e.g., poly(arylene sulfide) particles) to pass through until the particles (e.g., poly(arylene sulfide) particles) would be reduced to a required size (e.g., less than about 2.38 mm). In such embodiment, the particles (e.g., poly(arylene sulfide) particles) that are too large to pass through the screen or sieve (e.g., woven wire test sieve) would be retained in the device until the particles (e.g., poly(arylene sulfide) particles) would be mechanically sized (e.g., ground) to a particle size small enough to pass through the screen or sieve (e.g., woven wire test sieve), e.g., a particle size of less than about 2.38 mm. As will be appreciated by one of skill in the art, and with the help of this disclosure, when a device including a screen or sieve is used for mechanically sizing polymer particles (e.g., poly(arylene sulfide) particles), redirecting steps (e.g., redirecting step 233, redirecting step 234, etc.) are not necessary, as the polymer particles (e.g., poly(arylene sulfide) particles) stay (e.g., are retained) in the device until reaching an appropriate/required size, e.g., until they can pass through the screen or sieve (e.g., woven wire test sieve), such as for example until they reach a particle size of less than about 2.38 mm. In such embodiment, at least a portion of the particles (e.g., poly(arylene sulfide) particles) leaving (e.g., exiting) the device can be further subjected to the step of contacting poly(arylene sulfide) particles with an aqueous solution 150.

Referring to FIG. 1A, in another embodiment, at least a portion of the raw poly(arylene sulfide) polymer particles directed 122 to a step of distinguishing small poly(arylene sulfide) particles from large poly(arylene sulfide) particles can be first subjected to a step of distinguishing by mechanically sizing or mechanically reducing the size 132 as depicted in FIG. 1C. Referring to the embodiment of FIG. 1C, at least a portion of the raw poly(arylene sulfide) polymer particles are subjected to a step of mechanically sizing poly(arylene sulfide) particles 310 to yield mechanically sized poly(arylene sulfide) polymer particles, followed by a step of particle size distribution determination (e.g., screening of a sample) 320. The particle size distribution determination (e.g., screening of a sample) 320 can be performed on at least a portion of the mechanically sized poly(arylene sulfide) polymer particles, as previously described herein. In an embodiment, if less than 10 wt. % of the mechanically sized poly(arylene sulfide) polymer particles have a particle size of equal to or greater than about 2.38 mm, at least a portion of the mechanically sized poly(arylene sulfide) polymer particles can be directed 321 to the step of contacting poly(arylene sulfide) particles with an aqueous solution 150. In an alternative embodiment, if equal to or greater than 10 wt. % of the mechanically sized poly(arylene sulfide) polymer particles have a particle size of equal to or greater than about 2.38 mm, at least a portion of the mechanically sized poly(arylene sulfide) polymer particles can be further directed 322 either (i) via path 323 to a step of separating small poly(arylene sulfide) particles from large poly(arylene sulfide) particles 330 (e.g., via screening, shakers, etc.) or (ii) via path 324 to the step of mechanically sizing poly(arylene sulfide) particles 310. In the case when at least a portion of the mechanically sized poly(arylene sulfide) polymer particles are directed via path 323 to a step of separating small poly(arylene sulfide) particles from large poly(arylene sulfide) particles 330, a small poly(arylene sulfide) particles fraction 331 and a large poly(arylene sulfide) particles fraction 332 can be obtained. At least a portion of the small poly(arylene sulfide) particles fraction 331 can be further subjected to the step of contacting poly(arylene sulfide) particles with an aqueous solution 150. At least a portion of the large poly(arylene sulfide) particles fraction 332 can be redirected back to the step of mechanically sizing poly(arylene sulfide) particles 310.

In an embodiment, a piece of equipment or device can be designed (e.g., used) to accommodate the step of mechanically sizing poly(arylene sulfide) particles 310, the step of particle size distribution determination (e.g., screening of a sample) 320, and the step of separating small poly(arylene sulfide) particles from large poly(arylene sulfide) particles 330, such as for example a grinding machine equipped with a screen or sieve (e.g., woven wire test sieve) that would not allow particles (e.g., poly(arylene sulfide) particles) to pass through until the particles (e.g., poly(arylene sulfide) particles) would be reduced to a required size (e.g., less than about 2.38 mm). In such embodiment, the particles (e.g., poly(arylene sulfide) particles) that are too large to pass through the screen or sieve (e.g., woven wire test sieve) would be retained in the device until the particles (e.g., poly(arylene sulfide) particles) would be mechanically sized (e.g., ground) to a particle size small enough to pass through the screen or sieve (e.g., woven wire test sieve), e.g., a particle size less than about 2.38 mm. As will be appreciated by one of skill in the art, and with the help of this disclosure, when a device including a screen or sieve is used for mechanically sizing polymer particles (e.g., poly(arylene sulfide) particles), redirecting steps (e.g., redirecting step 323, redirecting step 324, etc.) are not necessary, as the polymer particles (e.g., poly(arylene sulfide) particles) stay (e.g., are retained) in the device until reaching an appropriate/required size, e.g., until they can pass through the screen or sieve (e.g., woven wire test sieve), such as for example until they reach a particle size of less than about 2.38 mm. In such embodiment, at least a portion of the particles (e.g., poly(arylene sulfide) particles) leaving (e.g., exiting) the device can be further subjected to the step of contacting poly(arylene sulfide) particles with an aqueous solution 150.

Referring to the embodiment of FIG. 1A, at least a portion of the poly(arylene sulfide) polymer particles that are obtained from the step of contacting poly(arylene sulfide) particles with an aqueous solution 150 (e.g., treated poly(arylene sulfide) polymer particles) can be further subjected to a step of recovering treated poly(arylene sulfide) particles 160.

In an embodiment, the small poly(arylene sulfide) polymer particles (e.g., distinguished small poly(arylene sulfide) polymer particles, treated small poly(arylene sulfide) polymer particles, etc.) have a particle size that is characterized by equal to or greater than about 95 wt. % of the polymer particles that can pass through an 8 mesh (i.e., 2.38 mm, based on U.S. Sieve Series) woven wire test sieve, alternatively equal to or greater than about 98 wt. %, or alternatively about 100 wt. %. In an embodiment, the small poly(arylene sulfide) polymer particles can have a particle size that is characterized by equal to or greater than about 95 wt. % of the polymer particles that can pass through a 12 mesh (i.e., 1.68 mm, based on U.S. Sieve Series) woven wire test sieve, alternatively equal to or greater than about 98 wt. %, or alternatively about 100 wt. %. In an embodiment, the small poly(arylene sulfide) polymer particles can have a particle size that is characterized by equal to or greater than about 95 wt. % of the polymer particles that can pass through a 16 mesh (i.e., 1.20 mm, based on U.S. Sieve Series) woven wire test sieve, alternatively equal to or greater than about 98 wt. %, or alternatively about 100 wt. %.

In an embodiment, the step to distinguish small poly(arylene sulfide) polymer particles from large poly(arylene sulfide) polymer particles 130 (e.g., step 210 of FIG. 1B or step 330 of FIG. 1C) can comprise separating at least a portion of the poly(arylene sulfide) polymer particles based on their size (e.g., sifting, sieving, etc.), such that the small poly(arylene sulfide) polymer particles are physically separated from (e.g., not in contact with) the large poly(arylene sulfide) polymer particles, to yield distinguished small poly(arylene sulfide) polymer particles (e.g., separated small poly(arylene sulfide) polymer particles). In an embodiment, the step to distinguish small poly(arylene sulfide) polymer particles from large poly(arylene sulfide) polymer particles can yield separated small poly(arylene sulfide) polymer particles. In an embodiment, the small poly(arylene sulfide) polymer particles can be separated from the large poly(arylene sulfide) polymer particles by using any suitable methodology.

In an embodiment, at least a portion of the small poly(arylene sulfide) polymer particles can be separated from the large poly(arylene sulfide) polymer particles by screening (e.g., sifting, sieving) the particles. In an embodiment, at least a portion of the poly(arylene sulfide) polymer particles can be separated in a dry separation process or a wet separation process; alternatively, in a dry separation process; or alternatively, in a wet separation process.

In a screening (e.g., sifting, sieving) process, the particles having different sizes can be placed on a screen (e.g., a sieve, a woven wire test sieve, etc.) having an aperture of a pre-determined size (e.g., nominal aperture dimension), such that only particles of less than the size of the aperture can pass through. In an embodiment, the screen (e.g., sieve, woven wire test sieve, etc.) used for separating at least a portion of the small poly(arylene sulfide) polymer particles from the large poly(arylene sulfide) polymer particles comprises an aperture configured to allow polymer particles with a particle size of less than about 2.38 mm, alternatively, less than about 1.68 mm, or alternatively, less than about 1.20 mm, to pass through. In an embodiment, the screens (e.g., sieves) can be stationary screens (i.e., immobile screens) or moving screens. An external force is generally applied to the moving screen (e.g., sieve) to impart a movement (e.g., vibrating movement, circular movement, linear movement, sideways movement, up and down movement, revolving movement, centrifugal movement, gyrating movement, or combinations thereof) to the screen (e.g., sieve), such that the small particles can pass through the apertures of the screen (e.g., sieve). In an embodiment, any suitable separating device can be used for separating small poly(arylene sulfide) polymer particles from large poly(arylene sulfide) polymer particles. In such embodiment, a device for separating small poly(arylene sulfide) polymer particles from large poly(arylene sulfide) polymer particles can be configured to perform the separation of the polymer particles in accordance with ASTM E11-09 and ASTM D1921-12, as previously described herein. Nonlimiting examples of separating devices suitable for use in the present disclosure include stationary screens, stationary grizzlies, moving screens, moving grizzlies, gyrating screens, gyrating grizzlies, vibrating screens, vibrating grizzlies, trommel screens, banana screens, centrifugal sifters, or combinations thereof.

In an embodiment, at least a portion of the small poly(arylene sulfide) polymer particles can be separated from the large poly(arylene sulfide) polymer particles by subjecting a slurry containing the poly(arylene sulfide) polymer particles to a wet separation process. In such an embodiment, at least a portion of the poly(arylene sulfide) polymer particles to be separated can be slurried in any suitable liquid, such as for example a polar organic compound (e.g., NMP), water, an aqueous solution, and aqueous acidic solution, etc. In an embodiment, at least a portion of the slurry containing the poly(arylene sulfide) polymer particles can be subjected to a separation by filtration process, where the slurry can be run through a filter having a pore size (e.g., opening in the filter for particles to pass through) of a pre-determined size, such that only particles of less than the size of the pore can pass through. In an embodiment, the filter used for separating at least a portion of the small poly(arylene sulfide) polymer particles from the large poly(arylene sulfide) polymer particles comprises a pore configured to allow polymer particles with a particle size of less than about 2.38 mm, alternatively, less than about 1.68 mm, or alternatively, less than about 1.20 mm, to pass through. In an embodiment, any suitable filtration device (e.g., a filter) can be used for separating at least a portion of small poly(arylene sulfide) polymer particles from large poly(arylene sulfide) polymer particles. In an embodiment, a filtration device for separating small poly(arylene sulfide) polymer particles from large poly(arylene sulfide) polymer particles can be configured to perform the separation of the polymer particles in accordance with ASTM E11-09 and ASTM D1921-12, as previously described herein. Nonlimiting examples of filtration devices suitable for use in the present disclosure include a classifier, a gravity settling classifier, a Spitzcasten classifier, a mechanical classifier, a rake classifier, a spiral classifier, a sink-and-float separator, a jig separator, or combinations thereof. As will be appreciated by one of skill in the art, and with the help of this disclosure, at least a portion of the small poly(arylene sulfide) polymer particles that have been separated from a slurry can also be subjected to a drying step (e.g., removal of the slurry liquid) prior to further processing.

In an embodiment, the step to distinguish small poly(arylene sulfide) polymer particles from the large poly(arylene sulfide) polymer particles can comprise mechanically reducing the size of or mechanically sizing (e.g., grinding) at least a portion of the large poly(arylene sulfide) polymer particles to obtain distinguished small poly(arylene sulfide) polymer particles, such as for example mechanically sized small poly(arylene sulfide) polymer particles (e.g., step 220 of FIG. 1B or step 310 of FIG. 1C). In an embodiment, a step of mechanically sizing poly(arylene sulfide) polymer particles can occur prior to, concurrent with, and/or subsequent to a step of separating small poly(arylene sulfide) particles from large poly(arylene sulfide) particles, as previously described herein. In an embodiment, the small poly(arylene sulfide) polymer particles can be obtained from large poly(arylene sulfide) polymer particles by using any suitable methodology. In an embodiment, at least a portion of the small poly(arylene sulfide) polymer particles can be obtained from large poly(arylene sulfide) polymer particles (e.g., large poly(arylene sulfide) polymer particles that have been separated from small poly(arylene sulfide) polymer particles as previously described herein); from a poly(arylene sulfide) polymer comprising large poly(arylene sulfide) polymer particles; from a poly(arylene sulfide) polymer comprising both large poly(arylene sulfide) polymer particles and small poly(arylene sulfide) polymer particles; or combinations thereof. In such embodiment, a poly(arylene sulfide) polymer that can be subjected to a step of mechanically sizing poly(arylene sulfide) polymer particles comprises about 100 wt. % large poly(arylene sulfide) polymer particles, alternatively, equal to or greater than about 90 wt. % large poly(arylene sulfide) polymer particles, alternatively, equal to or greater than about 80 wt. % large poly(arylene sulfide) polymer particles, alternatively, equal to or greater than about 70 wt. % large poly(arylene sulfide) polymer particles, alternatively, equal to or greater than about 60 wt. % large poly(arylene sulfide) polymer particles, alternatively, equal to or greater than about 50 wt. % large poly(arylene sulfide) polymer particles, alternatively, equal to or greater than about 40 wt. % large poly(arylene sulfide) polymer particles, alternatively, equal to or greater than about 30 wt. % large poly(arylene sulfide) polymer particles, alternatively, equal to or greater than about 20 wt. % large poly(arylene sulfide) polymer particles, or alternatively, equal to or greater than about 10 wt. % large poly(arylene sulfide) polymer particles, based on the total weight of the poly(arylene sulfide) polymer. In such embodiment, the poly(arylene sulfide) polymer that can be subjected to a step of mechanically sizing poly(arylene sulfide) polymer particles comprises large poly(arylene sulfide) polymer particles.

In an embodiment, mechanically reducing the size of (e.g., grinding) at least a portion of large poly(arylene sulfide) polymer particles to obtain small poly(arylene sulfide) polymer particles can rely on impact, compression, shear, or combinations thereof. For example, grinding relies on impact, either impacting a particle with an outside force, or impacting (e.g., accelerating) a particle against another particle; compression involves size reduction caused predominantly by pressure, but also by friction from the surfaces of the neighboring particles; shearing, or stressing by cutting, generally makes use of rotary knife cutters that cut materials on shearing edges.

In an embodiment, mechanically reducing the size of (e.g., grinding) at least a portion of large poly(arylene sulfide) polymer particles to obtain small poly(arylene sulfide) polymer particles can involve the use of grinders, mills, impact mills, long-gap mills, fluid energy impact mills, spiral jet mills, fluidized-bed jet mills, cutting mills, crushers, granulators, hammer mills, vibrating screen hammer mills, cryogenic impact mills, screen mills, universal mills, fine-grinding impact mills, pin mills, mills with classifiers, air-classifier mills, roller mills, disc mills, attrition mills, air swept pulverizers, or combinations thereof.

In an embodiment, at least a portion of the small poly(arylene sulfide) polymer particles obtained via a separation step can be combined with at least a portion of the small poly(arylene sulfide) polymer particles obtained via a mechanically sizing step. In such an embodiment, at least a portion of the separated small poly(arylene sulfide) polymer particles can be combined with at least a portion of the mechanically sized small poly(arylene sulfide) polymer particles prior to, concurrent with, and/or subsequent to contacting at least a portion of the small poly(arylene sulfide) polymer particles with an aqueous solution. In an embodiment, at least a portion of the separated small poly(arylene sulfide) polymer particles can be combined with at least a portion of the mechanically sized small poly(arylene sulfide) polymer particles prior to contacting at least a portion of the combined small poly(arylene sulfide) polymer particles with an aqueous solution.

As will be apparent to one of skill in the art, and with the help of this disclosure, the small poly(arylene sulfide) polymer particles that have been distinguished (e.g., separated, mechanically sized) from the large poly(arylene sulfide) polymer particles can comprise a minute amount of large poly(arylene sulfide) polymer particles. In an embodiment, the distinguished small poly(arylene sulfide) polymer particles can comprise large poly(arylene sulfide) polymer particles in an amount of less than about 5 wt. %, alternatively, less than about 4 wt. %, alternatively, less than about 3 wt. %, alternatively, less than about 2 wt. %, alternatively, less than about 1 wt. %, alternatively, less than about 0.5 wt. %, alternatively, less than about 0.1 wt. %, alternatively, less than about 0.01 wt. %, alternatively, less than about 0.001 wt. %, alternatively, less than about 0.0001 wt. %, or alternatively, less than about 0.00001 wt. %, based on the total weight of the small poly(arylene sulfide) polymer particles.

In an embodiment, the distinguished (e.g., separated, mechanically sized) small poly(arylene sulfide) polymer particles comprise greater than about 90 wt. %, 91 wt. %, 92 wt. %, 93 wt. %, 94 wt. %, 95 wt. %, 96 wt. %, 97 wt. %, 98 wt. %, 99 wt. % particles having a particle size of less than about 2.38 mm, alternatively less than about 1.68 mm, alternatively less than about 1.20 mm, or combinations thereof.

In an embodiment, the small poly(arylene sulfide) polymer particles prior to treatment (e.g., contacting with an aqueous solution) can be characterized by a melt crystallization temperature of equal to or greater than about 150° C., alternatively, equal to or greater than about 170° C., or alternatively, equal to or greater than about 180° C., as measured by differential scanning calorimetry according to ASTM D3418-12. Without wishing to be limited by theory, the melt crystallization temperature of a polymer refers to the temperature at which the polymer transitions to the crystalline state.

In an embodiment, the small poly(arylene sulfide) polymer particles prior to treatment (e.g., contacting with an aqueous solution) can be characterized by a sodium content of from about 300 ppm to about 10000 ppm, alternatively, from about 300 ppm to about 3000 ppm, alternatively, from about 500 ppm to about 2000 ppm, or alternatively, from about 1000 ppm to about 1500 ppm, based on the total weight of the small poly(arylene sulfide) polymer particles, as measured by atomic absorption spectroscopy.

In an embodiment, a method of the present disclosure comprises treating small poly(arylene sulfide) polymer particles with an aqueous solution (e.g., water, tap water, aqueous acid solution, aqueous metal cation solution, etc.) to improve the melt properties of the poly(arylene sulfide) polymer. In an embodiment, treating at least a portion of the small poly(arylene sulfide) polymer particles comprises contacting at least a portion of the small poly(arylene sulfide) polymer particles with an aqueous solution (e.g., water, tap water, aqueous acid solution, aqueous metal cation solution, etc.) to yield treated small poly(arylene sulfide) polymer particles (e.g., aqueous solution treated poly(arylene sulfide) polymer particles, acid treated small poly(arylene sulfide) polymer particles, metal cation treated poly(arylene sulfide) polymer particles, etc.). In an embodiment, at least a portion of the small poly(arylene sulfide) polymer particles can undergo one or more steps of contacting with an aqueous solution prior to, concurrent with, and/or subsequent to a step to distinguish at least a portion of small poly(arylene sulfide) polymer particles from large poly(arylene sulfide) polymer particles as previously described herein. In an embodiment, at least a portion of the small poly(arylene sulfide) polymer particles can undergo one or more steps of contacting with an aqueous solution subsequent to distinguishing at least a portion of small poly(arylene sulfide) particles from large poly(arylene sulfide) particles as previously described herein.

In an embodiment, a method of the present disclosure comprises contacting at least a portion of a poly(arylene sulfide) polymer with an aqueous solution (e.g., water, tap water, aqueous acid solution, aqueous metal cation solution, etc.). In such embodiment, a poly(arylene sulfide) polymer that can be subjected to a step of treating (e.g., contacting with an aqueous solution) poly(arylene sulfide) polymer particles comprises greater than about 90 wt. %, 91 wt. %, 92 wt. %, 93 wt. %, 94 wt. %, 95 wt. %, 96 wt. %, 97 wt. %, 98 wt. %, 99 wt. % small poly(arylene sulfide) polymer particles, based on the total weight of the poly(arylene sulfide) polymer. In an embodiment, the poly(arylene sulfide) polymer that can be subjected to a step of treating (e.g., contacting with an aqueous solution) poly(arylene sulfide) polymer particles comprises about 100 wt. % small poly(arylene sulfide) polymer particles. While the present disclosure will be discussed in detail in the context of contacting small poly(arylene sulfide) polymer particles with an aqueous solution to improve the melt properties of the poly(arylene sulfide) polymer, it should be understood that other sizes of polymer particles (e.g., large poly(arylene sulfide) polymer particles, polymers comprising both small and large poly(arylene sulfide) polymer particles, etc.) can undergo a step of contacting with an aqueous solution to improve the melt properties of such polymer particles.

In an embodiment, at least a portion of the small poly(arylene sulfide) polymer particles can be contacted with an aqueous solution. In such embodiment, the aqueous solution comprises water, tap water, an aqueous acid solution, an aqueous metal cation solution, and combinations thereof

In an embodiment, at least a portion of the small poly(arylene sulfide) polymer particles can be contacted with an aqueous acid solution (e.g., acid treatment) to yield acid treated small poly(arylene sulfide) polymer particles. Contacting the small poly(arylene sulfide) polymer particles with an aqueous acid solution (e.g., acid treatment) can comprise a) contacting at least a portion of the small poly(arylene sulfide) polymer particles with water to form a poly(arylene sulfide) slurry (e.g., PPS slurry), b) contacting at least a portion of the poly(arylene sulfide) slurry (e.g., PPS slurry) with an acidic compound to form a mixture (e.g., mixing the poly(arylene sulfide) slurry (e.g., PPS slurry) with an acidic compound to reach a desired pH value), c) heating at least a portion of the mixture in substantial absence of a gaseous oxidizing atmosphere to an elevated temperature below the melting point of the poly(arylene sulfide) (e.g., PPS), and d) recovering at least a portion of an acid treated poly(arylene sulfide) (e.g., an acid treated PPS); alternatively, a) contacting at least a portion of the small poly(arylene sulfide) polymer particles with aqueous solution comprising an acidic compound to form a mixture, b) heating at least a portion of the mixture in substantial absence of a gaseous oxidizing atmosphere to an elevated temperature below the melting point of the poly(arylene sulfide) (e.g., PPS), and c) recovering at least a portion of an acid treated poly(arylene sulfide) (e.g., acid treated PPS).

In an embodiment, the mixture of the small poly(arylene sulfide) polymer particles and the aqueous acid solution can have a pH of from about 1 to about 8, alternatively, from about 3 to about 7, alternatively, from about 4 to about 6, or alternatively, from about 4.5 to about 5. The acidic compound can be any organic acid or inorganic acid which is water soluble under the conditions of the acid treatment; alternatively, an organic acid which is water soluble under the conditions of the acid treatment; or alternatively, an inorganic acid which is water soluble under the conditions of the acid treatment. Generally, the organic acid which can be utilized in the acid treatment can be any organic acid which is water soluble under the conditions of the acid treatment. In an embodiment, the organic acid which can be utilized in the acid treatment process can comprise, or consist essentially of, a C₁ to C₁₅ carboxylic acid; alternatively, a C₁ to C₁₀ carboxylic acid; or alternatively, a C₁ to C₅ carboxylic acid. In an embodiment, the organic acid which can be utilized in the acid treatment process can comprise, or consist essentially of, acetic acid, formic acid, oxalic acid, fumaric acid, and monopotassium phthalic acid; alternatively, acetic acid; alternatively, formic acid; alternatively, oxalic acid; or alternatively, fumaric acid. Inorganic acids which can be utilized in the acid treatment process can comprise, or consist essentially of, hydrochloric acid, monoammonium phosphate, sulfuric acid, phosphoric acid, boric acid, sodium dihydrogen phosphate, ammonium dihydrogen phosphate, carbonic acid, and sulfurous acid; alternatively, hydrochloric acid; alternatively, sulfuric acid; alternatively, phosphoric acid; or alternatively, boric acid. In an embodiment, the acid which can be utilized in the acid treatment process comprises acetic acid.

The amount of the acidic compound present in the mixture of the small poly(arylene sulfide) polymer particles and the aqueous acid solution can range from about 0.01 wt. % to about 10 wt. %, alternatively, from about 0.025 wt. % to about 5 wt. %, or alternatively, from about 0.075 wt. % to about 1 wt. %, based on total amount of water in the mixture. The amount of the small poly(arylene sulfide) polymer particles present in the mixture of the small poly(arylene sulfide) polymer particles and the aqueous acid solution can range from about 1 wt. % to about 50 wt. %, alternatively, from about 5 wt. % to about 40 wt. %, or alternatively, from about 10 wt. % to about 30 wt. %, based upon the total weight of the mixture. Generally, the elevated temperature below the melting point of the poly(arylene sulfide) can range from about 165° C. to about 10° C., from about 150° C. to about 15° C., or from about 125° C. to about 20° C. below the melting point of the poly(arylene sulfide) (e.g., PPS); or alternatively, can range from about 175° C. to about 275° C., or from about 200° C. to about 250° C. Additional features of the acid treatment process are described in more detail in U.S. Pat. No. 4,801,644, which is incorporated by reference herein in its entirety.

Additionally or alternatively to an acid treatment, in an embodiment, at least a portion of the small poly(arylene sulfide) polymer particles can be contacted with an aqueous metal cation solution (e.g., metal cation treatment) to yield metal cation treated small poly(arylene sulfide) polymer particles. Contacting the small poly(arylene sulfide) polymer particles with an aqueous metal cation solution (e.g., metal cation treatment) can comprise a) contacting at least a portion of the small poly(arylene sulfide) polymer particles with water to form a poly(arylene sulfide) slurry (e.g., PPS slurry), b) contacting at least a portion of the poly(arylene sulfide) slurry (e.g., PPS slurry) with a Group 1, Group 2 or transition metal compound to form a mixture, c) heating at least a portion of the mixture in substantial absence of a gaseous oxidizing atmosphere to an elevated temperature below the melting point of the poly(arylene sulfide) (e.g., PPS), and d) recovering at least a portion of a metal cation treated poly(arylene sulfide) (e.g., metal cation treated PPS); alternatively, a) contacting at least a portion of the small poly(arylene sulfide) polymer particles with an aqueous solution comprising Group 1, Group 2 or transition metal compound to form a mixture, b) heating at least a portion of the mixture in substantial absence of a gaseous oxidizing atmosphere to an elevated temperature below the melting point of the poly(arylene sulfide) (e.g., PPS), and c) recovering at least a portion of a metal cation treated poly(arylene sulfide) (e.g., metal cation treated PPS).

The Group 1, Group 2 or transition metal compound can be any organic Group 1, Group 2 or transition metal compound or inorganic Group 1, Group 2 or transition metal compound which is water soluble under the conditions of the metal cation treatment; alternatively, an organic Group 1, Group 2 or transition metal compound which is water soluble under the conditions of the metal cation treatment; or alternatively, an inorganic Group 1, Group 2 or transition metal compound which is water soluble under the conditions of the metal cation treatment. Organic Group 1, Group 2 or transition metal compounds which can be utilized in the metal cation treatment process can comprise, or consist essentially of, a Group 1, Group 2 or transition metal C₁ to C₁₅ carboxylate; alternatively, a Group 1, Group 2 or transition metal C₁ to C₁₀ carboxylate; or alternatively, a Group 1, Group 2 or transition metal C₁ to C₅ carboxylate (e.g., formate, acetate). Inorganic Group 1, Group 2 or transition metal compounds which can be utilized in the metal cation treatment process can comprise, or consist essentially of, a Group 1, Group 2 or transition metal oxide or hydroxide (e.g., calcium oxide, magnesium oxide, calcium hydroxide or magnesium hydroxide, or mixtures thereof); alternatively, a Group 1, Group 2 or transition metal chloride; alternatively, a Group 1, Group 2 or transition metal chlorate; alternatively, a Group 1, Group 2 or transition metal perchlorate; alternatively, a Group 1, Group 2 or transition metal bromide; alternatively, a Group 1, Group 2 or transition metal bromate; alternatively, a Group 1, Group 2 or transition metal iodide; alternatively, a Group 1, Group 2 or transition metal iodate; alternatively, a Group 1, Group 2 or transition metal permanganate; alternatively, a Group 1, Group 2 or transition metal nitrate; alternatively, a Group 1, Group 2 or transition metal nitrite; alternatively, a Group 1, Group 2 or transition metal bicarbonate; or alternatively, a Group 1, Group 2 or transition metal sulfate. In an embodiment, the metal cations which can be utilized in the metal cation treatment process can comprise, or consist essentially of, calcium cations, magnesium cations, zinc cations, copper cations, and iron cations; alternatively, calcium cations; alternatively, magnesium cations; alternatively, zinc cations; alternatively, copper cations; or alternatively, iron cations. In an embodiment, the metal cations which can be utilized in the metal cation treatment process comprises calcium cations.

In an embodiment, the inorganic Group 1, Group 2 or transition metal compounds which can be utilized in the metal cation treatment process can comprise, or consist essentially of, calcium chloride, calcium chlorate, calcium perchlorate, calcium bromide, calcium bromate, calcium formate, calcium iodide, calcium permanganate, calcium nitrate, calcium nitrite, calcium bicarbonate, copper (II) bromide, copper (II) chloride, copper (II) chlorate, copper (II) perchlorate, copper (II) formate, copper (II) nitrate, copper (II) sulfate, iron (II) bromide, iron (II) chloride, iron (II) perchlorate, iron (II) nitrate, iron (II) sulfate, iron (III) chloride, iron (III) perchlorate, iron (III) nitrate, iron (III) sulfate, magnesium acetate, magnesium bromide, magnesium chloride, magnesium chlorate, magnesium perchlorate, magnesium formate, magnesium iodide, magnesium iodate, magnesium nitrate, magnesium sulfate, zinc acetate, zinc bromide, zinc chloride, zinc chlorate, zinc formate, zinc iodide, zinc permanganate, zinc sulfate, or mixtures thereof.

The amount of the Group 1, Group 2 or transition metal compound present in the mixture of the small poly(arylene sulfide) polymer particles and the aqueous metal cation solution can range from about 50 ppm to about 10,000 ppm, alternatively, from about 75 ppm to about 7,500 ppm, or alternatively, from about 100 ppm to about 5,000 ppm. Generally, the amount of the Group 1, Group 2 or transition metal compound is by the total weight of the mixture of the small poly(arylene sulfide) polymer particles and the aqueous metal cation solution. The amount of the small poly(arylene sulfide) polymer particles present in the mixture of the small poly(arylene sulfide) polymer particles and the aqueous metal cation solution can range from about 10 wt. % to about 60 wt. %, alternatively, from about 15 wt. % to about 55 wt. %, or alternatively, from about 20 wt. % to about 50 wt. %, based upon the total weight of the mixture of the small poly(arylene sulfide) polymer particles and the aqueous metal cation solution. Generally, the elevated temperature below the melting point of the poly(arylene sulfide) can range from about 165° C. to about 10° C., from about 150° C. to about 15° C., or from about 125° C. to about 20° C. below the melting point of the poly(arylene sulfide) (e.g., PPS); or alternatively, can range from about 125° C. to about 275° C., or from about 150° C. to about 250° C. Additional features of the metal cation treatment process are provided in EP patent publication 0103279 A1, which is incorporated by reference herein in its entirety.

Once the small poly(arylene sulfide) polymer particles have been treated (e.g., acid treated, metal cation treated, etc.), at least a portion of the treated poly(arylene sulfide) can be recovered (e.g., isolated) from the aqueous solution (e.g., aqueous acid solution, aqueous metal cation solution, water, tap water, etc.). Generally, the process/steps for recovering the treated poly(arylene sulfide) (e.g., treated small poly(arylene sulfide) polymer particles) can be the same steps as those for recovering the raw poly(arylene sulfide) from the reaction mixture, as previously described herein.

In an embodiment, the treated poly(arylene sulfide) polymer particles (e.g., acid treated small poly(arylene sulfide) polymer particles, metal cation treated small poly(arylene sulfide) polymer particles, etc.) can be isolated by any process capable of separating a solid precipitate from a liquid. In an embodiment, procedures which can be utilized to recover (e.g., isolate) the treated poly(arylene sulfide) polymer particles (e.g., acid treated small poly(arylene sulfide) polymer particles, metal cation treated small poly(arylene sulfide) polymer particles, etc.) can include, but are not limited to, filtration, vacuum filtration, pressure filtration, centrifugation, sedimentation, decantation, flotation, froth flotation; alternatively, filtration; alternatively, vacuum filtration; or alternatively, pressure filtration.

In an embodiment, contacting the small poly(arylene sulfide) polymer particles with an aqueous solution can result in treated small poly(arylene sulfide) polymer particles (e.g., acid treated small poly(arylene sulfide) polymer particles, metal cation treated small poly(arylene sulfide) polymer particles, etc.) with desirable properties, e.g., higher melt crystallization temperature, lower melt crystallization temperature, lower sodium content, etc.

In an embodiment, at least a portion of the small poly(arylene sulfide) polymer particles (e.g., distinguished small poly(arylene sulfide) polymer particles) can be contacted with an aqueous acid solution to increase the melt crystallization temperature of the resultant treated small poly(arylene sulfide) polymer particles (e.g., acid treated small poly(arylene sulfide) polymer particles) when compared to the melt crystallization temperature of the small poly(arylene sulfide) polymer particles (e.g., distinguished small poly(arylene sulfide) polymer particles) prior to contacting with the aqueous acid solution.

In an embodiment, at least a portion of the small poly(arylene sulfide) polymer particles (e.g., distinguished small poly(arylene sulfide) polymer particles) can be contacted with an aqueous metal cation solution to decrease the melt crystallization temperature of the resultant treated small poly(arylene sulfide) polymer particles (e.g., metal cation treated small poly(arylene sulfide) polymer particles) when compared to the melt crystallization temperature of the small poly(arylene sulfide) polymer particles (e.g., distinguished small poly(arylene sulfide) polymer particles) prior to contacting with the aqueous metal cation solution.

In an embodiment, the treated small poly(arylene sulfide) polymer particles (e.g., acid treated small poly(arylene sulfide) polymer particles, metal cation treated small poly(arylene sulfide) polymer particles, etc.) can be characterized by a melt crystallization temperature of from about 180° C. to about 250° C., alternatively, from about 200° C. to about 250° C., alternatively, from about 200° C. to about 240° C., alternatively, from about 210° C. to about 245° C., alternatively, from about 210° C. to about 240° C., or alternatively, from about 220° C. to about 240° C., as measured by differential scanning calorimetry using a set ramp rate. In an embodiment, the treated small poly(arylene sulfide) polymer particles (e.g., acid treated small poly(arylene sulfide) polymer particles, metal cation treated small poly(arylene sulfide) polymer particles, etc.) can be characterized by a melt crystallization temperature of from about 220° C. to about 240° C.

In an embodiment, the treated small poly(arylene sulfide) polymer particles (e.g., acid treated small poly(arylene sulfide) polymer particles, metal cation treated small poly(arylene sulfide) polymer particles, etc.) can be characterized by a sodium content of less than about 300 ppm, alternatively, less than about 200 ppm, or alternatively, less than about 150 ppm, based on the total weight of the treated small poly(arylene sulfide) polymer particles, as measured by atomic absorption spectroscopy.

Once the poly(arylene sulfide) has been recovered (either in raw, acid treated, metal cation treated, or acid treated and metal cation treated form), at least a portion of the recovered poly(arylene sulfide) (e.g., recovered PPS) can be dried and optionally cured.

Generally, the poly(arylene sulfide) drying process can be performed at any temperature which can substantially dry the poly(arylene sulfide) (e.g., PPS). The drying process should result in substantially no oxidative curing of the poly(arylene sulfide) (e.g., PPS). For example, if the drying process is conducted at a temperature at or above about 100° C., the drying should be conducted in a substantially non-oxidizing atmosphere (e.g., in a substantially oxygen free atmosphere or at a pressure less than atmospheric pressure, for example under vacuum). When the drying process is conducted at a temperature below about 100° C., the drying process can be facilitated by performing the drying at a pressure less than atmospheric pressure so the liquid component can be vaporized from the poly(arylene sulfide) (e.g., PPS). When the poly(arylene sulfide) drying is performed below about 100° C., the presence of a gaseous oxidizing atmosphere will generally not result in a detectable curing of the poly(arylene sulfide) (e.g., PPS). Generally, air is considered to be a gaseous oxidizing atmosphere.

Poly(arylene sulfide) can be cured by subjecting at least a portion of the poly(arylene sulfide) to an elevated temperature, below its melting point, in the presence of gaseous oxidizing atmosphere. Any suitable gaseous oxidizing atmosphere can be used. For example, suitable gaseous oxidizing atmospheres include, but are not limited to, oxygen, any mixture of oxygen and an inert gas (e.g., nitrogen), or air; or alternatively, air. The curing temperature can range from about 1° C. to about 130° C. below the melting point of the poly(arylene sulfide) (e.g., PPS), from about 10° C. to about 110° C. below the melting point of the poly(arylene sulfide) (e.g., PPS), or from about 30° C. to about 85° C. below the melting point of the poly(arylene sulfide) (e.g., PPS). Agents that affect curing, such as peroxides, accelerants, and/or inhibitors, can be incorporated into the poly(arylene sulfide) (e.g., PPS). The cured poly(arylene sulfide) can be characterized generally as exhibiting high thermal stability and good chemical resistance, and can be useful, for example, in the production of coatings, films, and molded objects.

In an embodiment, the process to distinguish small poly(arylene sulfide) polymer particles from large poly(arylene sulfide) polymer particles comprises (i) beginning with raw poly(arylene sulfide) polymer particles wherein equal to or greater than 10 wt. % of the raw poly(arylene sulfide) polymer particles have a particle size of equal to or greater than 2.38 mm; (ii) separating at least a portion of the small poly(arylene sulfide) polymer particles from the large poly(arylene sulfide) polymer particles via screening as previously described herein, to yield a first small poly(arylene sulfide) polymer particles fraction and a large poly(arylene sulfide) polymer particles fraction; (iii) grinding at least a portion of the large poly(arylene sulfide) polymer particles fraction to yield a second small poly(arylene sulfide) polymer particles fraction; (iv) contacting at least a portion of the small poly(arylene sulfide) polymer particles with an aqueous acid solution prior to, concurrent with, and/or subsequent to combining the first and second small poly(arylene sulfide) polymer particles fractions, to yield acid treated small poly(arylene sulfide) polymer particles, wherein the aqueous acid solution comprises acetic acid and has a pH of from about 1 to about 8; and (v) recovering at least a portion of the acid treated small poly(arylene sulfide) polymer particles.

In an alternative embodiment, the process to distinguish small poly(arylene sulfide) polymer particles from large poly(arylene sulfide) polymer particles comprises (i) beginning with raw poly(arylene sulfide) polymer particles wherein equal to or greater than 10 wt. % of the raw poly(arylene sulfide) polymer particles have a particle size of equal to or greater than 2.38 mm; (ii) grinding at least a portion of the raw poly(arylene sulfide) polymer particles to yield small poly(arylene sulfide) polymer particles; (iii) contacting at least a portion of the small poly(arylene sulfide) polymer particles with an aqueous acid solution to yield acid treated small poly(arylene sulfide) polymer particles, wherein the aqueous acid solution comprises acetic acid and has a pH of from about 1 to about 8; and (iv) recovering at least a portion of the acid treated small poly(arylene sulfide) polymer particles.

In another embodiment, the process to distinguish small poly(arylene sulfide) polymer particles from large poly(arylene sulfide) polymer particles comprises (i) beginning with raw poly(arylene sulfide) polymer particles wherein equal to or greater than 10 wt. % of the raw poly(arylene sulfide) polymer particles have a particle size of equal to or greater than 2.38 mm; (ii) grinding at least a portion of the raw poly(arylene sulfide) polymer particles to yield ground poly(arylene sulfide) polymer particles; (iii) separating at least a portion of the ground poly(arylene sulfide) polymer particles into a first small poly(arylene sulfide) polymer particles fraction and a large poly(arylene sulfide) polymer particles fraction via screening as previously described herein; (iv) grinding at least a portion of the large poly(arylene sulfide) polymer particles fraction to yield a second small poly(arylene sulfide) polymer particles fraction; (v) contacting at least a portion of the small poly(arylene sulfide) polymer particles with an aqueous acid solution prior to, concurrent with, and/or subsequent to combining the first and second small poly(arylene sulfide) polymer particles fractions, to yield acid treated small poly(arylene sulfide) polymer particles, wherein the aqueous acid solution comprises acetic acid and has a pH of from about 1 to about 8; and (vi) recovering at least a portion of the acid treated small poly(arylene sulfide) polymer particles.

In yet another embodiment, the process to distinguish small poly(arylene sulfide) polymer particles from large poly(arylene sulfide) polymer particles comprises (i) beginning with raw poly(arylene sulfide) polymer particles wherein equal to or greater than 10 wt. % of the raw poly(arylene sulfide) polymer particles have a particle size of equal to or greater than 2.38 mm; (ii) separating at least a portion of the small poly(arylene sulfide) polymer particles from the large poly(arylene sulfide) polymer particles via screening as previously described herein, to yield a first small poly(arylene sulfide) polymer particles fraction and a large poly(arylene sulfide) polymer particles fraction; (iii) grinding at least a portion of the large poly(arylene sulfide) polymer particles fraction to yield a second small poly(arylene sulfide) polymer particles fraction; (iv) contacting at least a portion of the small poly(arylene sulfide) polymer particles with an aqueous metal cation solution prior to, concurrent with, and/or subsequent to combining the first and second small poly(arylene sulfide) polymer particles fractions, to yield metal cation treated small poly(arylene sulfide) polymer particles, wherein the metal cation comprises a calcium cation; and (v) recovering at least a portion of the metal cation treated small poly(arylene sulfide) polymer particles.

In still yet another embodiment, the process to distinguish small poly(arylene sulfide) polymer particles from large poly(arylene sulfide) polymer particles comprises (i) beginning with raw poly(arylene sulfide) polymer particles wherein equal to or greater than 10 wt. % of the raw poly(arylene sulfide) polymer particles have a particle size of equal to or greater than 2.38 mm; (ii) grinding at least a portion of the raw poly(arylene sulfide) polymer particles to yield small poly(arylene sulfide) polymer particles; (iii) contacting at least a portion of the small poly(arylene sulfide) polymer particles with an aqueous metal cation solution to yield metal cation treated small poly(arylene sulfide) polymer particles, wherein the metal cation comprises a calcium cation; and (iv) recovering at least a portion of the metal cation treated treated small poly(arylene sulfide) polymer particles.

In still yet another embodiment, the process to distinguish small poly(arylene sulfide) polymer particles from large poly(arylene sulfide) polymer particles comprises (i) beginning with raw poly(arylene sulfide) polymer particles wherein equal to or greater than 10 wt. % of the raw poly(arylene sulfide) polymer particles have a particle size of equal to or greater than 2.38 mm; (ii) grinding at least a portion of the raw poly(arylene sulfide) polymer particles to yield ground poly(arylene sulfide) polymer particles; (iii) separating at least a portion of the ground poly(arylene sulfide) polymer particles into a first small poly(arylene sulfide) polymer particles fraction and a large poly(arylene sulfide) polymer particles fraction via screening as previously described herein; (iv) grinding at least a portion of the large poly(arylene sulfide) polymer particles fraction to yield a second small poly(arylene sulfide) polymer particles fraction; (v) contacting at least a portion of the small poly(arylene sulfide) polymer particles with an aqueous metal cation solution prior to, concurrent with, and/or subsequent to combining the first and second small poly(arylene sulfide) polymer particles fractions, to yield metal cation treated small poly(arylene sulfide) polymer particles, wherein the metal cation comprises a calcium cation; and (vi) recovering at least a portion of the metal cation treated small poly(arylene sulfide) polymer particles.

In an aspect, the poly(arylene sulfide) described herein can further comprise one or more additives. In an embodiment, the poly(arylene sulfide) can ultimately be used or blended in a compounding process, for example, with various additives, such as polymers, fillers, fiber reinforcements, pigments, nucleating agents, antioxidants, ultraviolet (UV) stabilizers (e.g., UV absorbers), lubricants, fire retardants, heat stabilizers, carbon black, plasticizers, corrosion inhibitors, mold release agents, pigments, titanium dioxide, clay, mica, processing aids, adhesives, tackifiers, and the like, or combinations thereof.

In an embodiment, fillers which can be utilized include, but are not limited to, mineral fillers, inorganic fillers, or organic fillers, or mixtures thereof. In some embodiments, the filler can comprise, or consist essentially of, a mineral filler; alternatively, an inorganic filler; or alternatively, an organic filler. In an embodiment, mineral fillers which can be utilized include, but are not limited to, glass fibers, milled fibers, glass beads, asbestos, wollastonite, fiberglass, mica, talc, clay, calcium carbonate, magnesium hydroxide, silica, potassium titanate fibers, rockwool, or any combination thereof; alternatively, glass fibers; alternatively, glass beads; alternatively, asbestos, wollastonite; alternatively, fiberglass; alternatively, silica; alternatively, potassium titanate fibers; or alternatively, rockwool. Exemplary inorganic fillers can include, but are not limited to, aluminum flakes, zinc flakes, fibers of metals such as brass, aluminum, zinc, or any combination thereof; alternatively, aluminum flakes; alternatively, zinc flakes; or alternatively, fibers of metals such as brass, aluminum, and zinc. Exemplary organic fillers can include, but are not limited to, carbon fibers, carbon black, graphene, graphite, a fullerene, a buckyball, a carbon nanofiber, a carbon nanotube, or any combination thereof; alternatively, carbon fibers; alternatively, carbon black; alternatively, graphene; alternatively, graphite; alternatively, a fullerene; alternatively, a buckyball; alternatively, a carbon nanofiber; or alternatively, a carbon nanotube. Fibers such as glass fibers, milled fibers, carbon fibers and potassium titanate fibers, and inorganic fillers such as mica, talc, and clay can be incorporated into the composition, which can provide molded articles to provide a composition which can have improved properties.

In an embodiment, pigments which can be utilized include, but are not limited to, titanium dioxide, zinc sulfide, or zinc oxide, and mixtures thereof.

In an embodiment, UV absorbers which can be utilized include, but are not limited to, oxalic acid diamide compounds or sterically hindered amine compounds, and mixtures thereof.

In an embodiment, lubricants which can be utilized include, but are not limited to, polyethylene waxes, polypropylene waxes, and paraffins, and mixtures thereof.

In an embodiment, the fire retardant can be a phosphorus based fire retardant, a halogen based fire retardant, a boron based fire retardant, an antimony based fire retardant, an amide based fire retardant, or any combination thereof. In an embodiment, phosphorus based fire retardants which can be utilized include, but are not limited to, triphenyl phosphate, tricresyl phosphate, a phosphate obtained from a mixture of isopropylphenol and phenol and phosphorus oxychloride, or phosphate esters obtained from difunctional phenols (e.g., benzohydroquinone or bisphenol A), an alcohol, or a phenol and phosphorus oxychloride; alternatively, triphenyl phosphate; alternatively, tricresyl phosphate; alternatively, a phosphate obtained from a mixture of isopropylphenol and phenol and phosphorus oxychloride; or alternatively, phosphate esters obtained from difunctional phenols (e.g., benzohydroquinone or bisphenol A), an alcohol, or a phenol and phosphorus oxychloride. In an embodiment, halogen based fire retardants which can be utilized include, but are not limited to, brominated compounds. In some embodiments, the halogen based fire retardants which can be utilized include, but are not limited to, decabromobiphenyl, pentabromotoluene, decabromobiphenyl ether, hexabromobenzene, or brominated polystyrene. In an embodiment, stabilizers which can be utilized include, but are not limited to, sterically hindered phenols and phosphite compounds.

In an aspect, the poly(arylene sulfide) described herein can further be processed by melt processing. In an embodiment, melt processing can generally be any process, step(s) which can render the poly(arylene sulfide) in a soft or “moldable state.” In an embodiment, the melt processing can be a step wherein at least part of the polymer composition or mixture subjected to the process is in molten form. In some embodiments, the melt processing can be performed by melting at least part of the polymer composition or mixture. In some embodiments, the melt processing step can be performed with externally applied heat. In other embodiments, the melt processing step itself can generate the heat necessary to melt (or partially melt) the mixture, polymer, or polymer composition. In an embodiment, the melt processing step can be an extrusion process, a melt kneading process, or a molding process. In some embodiments, the melt processing step of any method described herein can be an extrusion process; alternatively, a melt kneading process; or alternatively, a molding process. It should be noted, that when any process described herein employs more than one melt processing step, that each melt process step is independent of each other and thus each melt processing step can use the same or different melt processing method. Other melt processing methods are known to those having ordinary skill in the art can be utilized as the melt processing step.

The poly(arylene sulfide) can be formed or molded into a variety of components or products for a diverse range of applications and industries. For example, the poly(arylene sulfide) can be heated and molded into desired shapes and composites in a variety of processes, equipment, and operations. For example, the poly(arylene sulfide) can be subjected to heat, compounding, injection molding, blow molding, precision molding, film-blowing, extrusion, and so forth. Additionally, additives, such as those mentioned herein, can be blended or compounded within the poly(arylene sulfide) (e.g., PPS). The output of such techniques can include, for example, polymer intermediates or composites including the poly(arylene sulfide) (e.g., PPS), and manufactured product components or pieces formed from the poly(arylene sulfide) (e.g., PPS), and so on. These manufactured components can be sold or delivered directly to a user. On the other hand, the components can be further processed or assembled in end products, for example, in the industrial, consumer, automotive, aerospace, solar panel, and electrical/electronic industries, which can need polymers that have conductivity, high strength, and high modulus, among other properties. Some examples of end products include without limitation synthetic fibers, textiles, filter fabric for coal boilers, papermaking felts, electrical insulation, specialty membranes, gaskets, and packing materials.

In an embodiment, the method of treating a poly(arylene sulfide) polymer with an aqueous solution (e.g., water, tap water, aqueous acid solution, aqueous metal cation solution) presents the advantage of improving the melt properties (e.g., melt crystallization temperature, sodium content) of the poly(arylene sulfide) polymer. In some embodiments, one or more steps to distinguish small poly(arylene sulfide) polymer particles from large poly(arylene sulfide) polymer particles followed by one or more steps to contact the small poly(arylene sulfide) polymer particles with an aqueous acid solution can present the advantages of increasing the melt crystallization temperature of the poly(arylene sulfide) polymer (e.g., equal to or greater than about 180° C.) and decreasing the sodium content of the poly(arylene sulfide) polymer (e.g., less than about 300 ppm, based on the total weight of the poly(arylene sulfide) polymer). In other embodiments, one or more steps to distinguish small poly(arylene sulfide) polymer particles from large poly(arylene sulfide) polymer particles followed by one or more steps to contact the small poly(arylene sulfide) polymer particles with an aqueous metal cation solution can present the advantages of decreasing the melt crystallization temperature of the poly(arylene sulfide) polymer (e.g., less than about 250° C.) and decreasing the sodium content of the poly(arylene sulfide) polymer (e.g., less than about 300 ppm, based on the total weight of the poly(arylene sulfide) polymer). In an embodiment, the method presents the further advantage of improving the ability of the poly(arylene sulfide) polymer particles to melt. For example, the small poly(arylene sulfide) polymer particles melt fully in the same amount of time that it takes for large poly(arylene sulfide) polymer particles to only partially melt. In an embodiment, the small poly(arylene sulfide) polymer particles (e.g., distinguished small poly(arylene sulfide) polymer particles) can further present the advantage of having an increased melt flow rate.

For the purpose of any U.S. national stage filing from this application, all publications and patents mentioned in this disclosure are incorporated herein by reference in their entireties, for the purpose of describing and disclosing the constructs and methodologies described in those publications, which might be used in connection with the methods of this disclosure. Any publications and patents discussed herein are provided solely for their disclosure prior to the filing date of the present application. Nothing herein is to be construed as an admission that the inventors are not entitled to antedate such disclosure by virtue of prior invention.

In any application before the United States Patent and Trademark Office, the Abstract of this application is provided for the purpose of satisfying the requirements of 37 C.F.R. §1.72 and the purpose stated in 37 C.F.R. §1.72(b) “to enable the United States Patent and Trademark Office and the public generally to determine quickly from a cursory inspection the nature and gist of the technical disclosure.” Therefore, the Abstract of this application is not intended to be used to construe the scope of the claims or to limit the scope of the subject matter that is disclosed herein. Moreover, any headings that can be employed herein are also not intended to be used to construe the scope of the claims or to limit the scope of the subject matter that is disclosed herein. Any use of the past tense to describe an example otherwise indicated as constructive or prophetic is not intended to reflect that the constructive or prophetic example has actually been carried out.

The present disclosure is further illustrated by the following examples, which are not to be construed in any way as imposing limitations upon the scope thereof On the contrary, it is to be clearly understood that resort can be had to various other aspects, embodiments, modifications, and equivalents thereof which, after reading the description herein, can be suggest to one of ordinary skill in the art without departing from the spirit of the present invention or the scope of the appended claims.

### EXAMPLES

The following examples are set forth to provide a detailed description of how the methods claimed herein are evaluated, and are not intended to limit the scope of what the inventors regard as their invention.

### Example 1

The properties of a PPS (polyphenylene sulfide) polymer were investigated. More specifically, the melt crystallization temperature and sodium content for PPS polymer samples were examined both prior to any contacting with an aqueous solution, e.g., prior to contacting with an aqueous acid solution, and subsequent to contacting the PPS polymer with an aqueous acid solution, e.g., acid treatment. The melt crystallization temperature was measured by differential scanning calorimetry (DSC) using a set ramp rate. The DSC method involved ramping the temperature from 40° C. to 350° C. at a rate of 20° C./min; the temperature was held at 350° C. for 10 minutes, and then the temperature was ramped down from 350° C. to 40° C. at a rate of 20° C./min. This DSC procedure was repeated to confirm the melt crystallization temperature. The sodium content, if there was enough sample, was measured by atomic absorption (AA) spectroscopy, and the AA instrument used was a Varian AA240FS, which was calibrated to measure Na, Ca, In, Mg, and Fe in ppm by weight. The samples were first digested in nitric acid, then separated by liquid filtration, and loaded (charged) into the AA instrument.

For each sample, 25 g of wet cake (e.g., PPS particulates still wet with the NMP polar organic compound from the manufacturing process) were treated (e.g., contacted, washed) with NMP at 170° F., and then filtered to remove most of the NMP polar organic compound. The NMP-treated PPS was then added to 100 mL of water, and in some cases the pH was adjusted to the desired value by using acetic acid, all under continuous stirring; the PPS particles that were treated with the acidic solution were subsequently filtered and treated with (e.g., washed in) water. After all treatments were terminated, the PPS particles were filtered through a 100 mesh (0.152 mm) screen, and solids (e.g., treated PPS) were retained, while filtrate passed through screen); dried for 3 hours at 300° F.; and analyses were performed, based on the amount of sample available at that point.

The PPS polymer particles were distinguished by size through separation using standard sieve size screens (e.g., woven wire test sieves).

Table 2 displays data for PPS particles prior to contacting with an aqueous solution (e.g., aqueous acetic acid solution). These samples were separated into different fractions based on their size. For sample #1, two fractions were studied, a fraction with particles having a size greater than 6 mesh (i.e., 3.35 mm, based on U.S. Sieve Series), and another fraction with particles having a size smaller than 8 mesh (i.e., 2.38 mm, based on U.S. Sieve Series). Sample #2 was separated into three fractions: a fraction with particles having a size greater than 6 mesh (i.e., 3.35 mm, based on U.S. Sieve Series), a fraction with particles having a size smaller than 8 mesh (i.e., 2.38 mm, based on U.S. Sieve Series), and another fraction with particles having a size greater than 8 mesh (i.e., 2.38 mm, based on U.S. Sieve Series).

TABLE 2

| | | | | | Sodium |
|---|---|---|---|---|---|
| | Particle | Particle | | Melt Crystallization | Content |
| | Size | Size | | Temperature | [ppm, by |
| Sample | [mesh] | [mm] | pH | [° F.] | weight] |
| #1 | >6 mesh | >3.35 mm | N/A | 181 | N/A |
| | <8 mesh | <2.38 mm | N/A | 203 | N/A |
| #2 | >6 mesh | >3.35 mm | N/A | 199 | 318 |
| | >8 mesh | >2.38 mm | N/A | 215 | 289 |
| | <8 mesh | <2.38 mm | N/A | 234 | 220 |

Table 2 displays data for PPS particles after contacting with an aqueous solution (e.g., aqueous acetic acid solution). For sample #3, two fractions were studied at two different pH values, a fraction with particles having a size greater than 6 mesh (i.e., 3.35 mm, based on U.S. Sieve Series), and another fraction with particles having a size smaller than 16 mesh (i.e., 1.20 mm, based on U.S. Sieve Series). For sample #4, PPS particles before any separation based on size (i.e., all particles, not distinguished by size) were treated with aqueous acidic solutions at different pH values and tested. Also for sample #4, the PPS particles were separated into three fractions, similar to sample #2. For sample #5, the particles were of a size greater than 6 mesh (i.e., 3.35 mm, based on U.S. Sieve Series), and a separate fraction was obtained by grinding the 6 mesh fraction (e.g., 6 mesh ground) to obtain a fraction with smaller size particles. A portion of sample #5 was subjected to a treatment with water, and another portion of sample #5 was treated with an aqueous acid solution (e.g., aqueous acetic acid solution).

TABLE 3

| | | | | Melt Crystallization | |
|---|---|---|---|---|---|
| | Particle Size | Particle Size | | Temperature | Sodium Content |
| Sample | [mesh] | [mm] | pH | [° F.] | [ppm, by weight] |
| #3 | >6 mesh | >3.35 mm | 6.0 | 190 | 441 |
| | <16 mesh | <1.20 mm | 6.0 | 216 | 280 |
| | >6 mesh | >3.35 mm | 5.0 | 197 | 315 |
| | <16 mesh | <1.20 mm | 5.0 | 240 | 156 |
| #4 | all particles, | all particles, | 9.3 | 190 | 730 |
| | not distinguished by size | not distinguished by size | | | |
| | all particles, | all particles, | 6.1 | 192 | 651 |
| | not distinguished by size | not distinguished by size | | | |
| | all particles, | all particles, | 5.0 | 191 | 592 |
| | not distinguished by size | not distinguished by size | | | |
| | all particles, | all particles, | 4.1 | 236 | 194 |
| | not distinguished by size | not distinguished by size | | | |
| | >6 mesh | >3.35 mm | 3.9 | 189 | 403 |
| | >8 mesh | >2.38 mm | 3.9 | 204 | 340 |
| | <8 mesh | <2.38 mm | 3.9 | 237 | 233 |
| #5 | >6 mesh control | >3.35 mm control | N/A | 174 | 361 |
| | 6 mesh ground control | 3.35 mm ground control | N/A | 186 | 336 |
| | >6 mesh | >3.35 mm | 5.0 | 190 | 267 |
| | 6 mesh ground | 3.35 mm ground | 5.0 | 230 | 161 |

A comparison of the data in Tables 2 and 3 indicates that for the same particle size fractions, the treatment (e.g., contacting, washing) with an aqueous acid solution increases the melt crystallization temperature and decreases the sodium content. Further, for the same treatment conditions, but different particle sizes, the smaller the particle size, the more enhanced the increase in the melt crystallization temperature and the decrease in the sodium content.

### Additional Disclosure

The following are additional enumerated embodiments of the concepts disclosed herein.

A first embodiment, which is a process comprising:
(a) beginning with a poly(arylene sulfide) polymer comprising a plurality of small poly(arylene sulfide) polymer particles and large poly(arylene sulfide) polymer particles, distinguishing at least a portion of the small poly(arylene sulfide) polymer particles from the large poly(arylene sulfide) polymer particles to yield distinguished small poly(arylene sulfide) polymer particles, wherein the small poly(arylene sulfide) polymer particles have a particle size of less than 2.38 mm and the large poly(arylene sulfide) polymer particles have a particle size of equal to or greater than 2.38 mm; and
(b) contacting at least a portion of the distinguished small poly(arylene sulfide) polymer particles with an aqueous solution to form treated small poly(arylene sulfide) polymer particles.

A second embodiment, which is the process of the first embodiment, wherein the poly(arylene sulfide) polymer has a particle size distribution equal to or greater than 10 wt. % large poly(arylene sulfide) polymer particles.

A third embodiment, which is the process of any of the first and second embodiments, further comprising recovering the treated small poly(arylene sulfide) polymer particles, wherein the treated small poly(arylene sulfide) polymer particles have (i) a melt crystallization temperature of from about 180° C. to about 250° C., and (ii) a sodium content of less than about 300 ppm, based on the weight of the treated small poly(arylene sulfide) polymer particles.

A fourth embodiment, which is the process of the third embodiment, wherein the treated small poly(arylene sulfide) polymer particles have a melt crystallization temperature of from about 220° C. to about 240° C.

A fifth embodiment, which is the process of any of the first to the fourth embodiments, wherein distinguishing at least a portion of the small poly(arylene sulfide) polymer particles from the large poly(arylene sulfide) polymer particles comprises separating at least a portion of the small poly(arylene sulfide) polymer particles from the large poly(arylene sulfide) polymer particles to yield the distinguished small poly(arylene sulfide) polymer particles.

A sixth embodiment, which is the process of any of the first to the fourth embodiments, wherein distinguishing at least a portion of the small poly(arylene sulfide) polymer particles from the large poly(arylene sulfide) polymer particles comprises mechanically reducing the size of at least a portion of the large poly(arylene sulfide) polymer particles to yield the distinguished small poly(arylene sulfide) polymer particles.

A seventh embodiment, which is the process of any of the first to the fourth embodiments, wherein distinguishing at least a portion of the small poly(arylene sulfide) polymer particles from the large poly(arylene sulfide) polymer particles comprises (i) separating at least a portion of the small poly(arylene sulfide) polymer particles from the large poly(arylene sulfide) polymer particles to yield separated small poly(arylene sulfide) polymer particles and separated large poly(arylene sulfide) polymer particles and (ii) mechanically reducing the size of at least a portion of the separated large poly(arylene sulfide) polymer particles to yield mechanically sized small poly(arylene sulfide) polymer particles; and further comprising:

combining at least a portion of the separated small poly(arylene sulfide) polymer particles and at least a portion of the mechanically sized small poly(arylene sulfide) polymer particles to yield the distinguished small poly(arylene sulfide) polymer particles prior to (b) contacting with an aqueous solution.

An eighth embodiment, which is the process of any of the first to the seventh embodiments, further comprising reacting a sulfur source and a dihaloaromatic compound in the presence of a polar organic compound to form the poly(arylene sulfide) polymer.

A ninth embodiment, which is the process of any of the first to the eighth embodiments, wherein the poly(arylene sulfide) is a poly(phenylene sulfide).

A tenth embodiment, which is the process of any of the first to the ninth embodiments, wherein the aqueous solution comprises an aqueous acid solution with a pH of from about 1 to about 8.

An eleventh embodiment, which is the process of the tenth embodiment, wherein the contacting at least a portion of the distinguished small poly(arylene sulfide) polymer particles with an aqueous acid solution increases the melt crystallization temperature of the resultant treated small poly(arylene sulfide) polymer particles when compared to the melt crystallization temperature of the distinguished small poly(arylene sulfide) polymer particles prior to (b) contacting with an aqueous solution.

A twelfth embodiment, which is the process of any of the tenth to the eleventh embodiments, wherein the aqueous acid solution is an aqueous acetic acid solution.

A thirteenth embodiment, which is the process of any of the first to the ninth embodiments, wherein the aqueous solution comprises an aqueous metal cation solution.

A fourteenth embodiment, which is the process of the thirteen embodiment, wherein the metal cation comprises a calcium cation.

A fifteenth embodiment, which is the process of any of the thirteenth to the fourteenth embodiments, wherein the contacting at least a portion of the distinguished small poly(arylene sulfide) polymer particles with an aqueous metal cation solution decreases the melt crystallization temperature of the resultant treated small poly(arylene sulfide) polymer particles when compared to the melt crystallization temperature of the distinguished small poly(arylene sulfide) polymer particles prior to (b) contacting with an aqueous solution.

A sixteenth embodiment, which is a process comprising:
(a) beginning with a poly(arylene sulfide) polymer comprising a plurality of small poly(arylene sulfide) polymer particles and large poly(arylene sulfide) polymer particles, distinguishing at least a portion of the small poly(arylene sulfide) polymer particles from the large poly(arylene sulfide) polymer particles to yield distinguished small poly(arylene sulfide) polymer particles, wherein the small poly(arylene sulfide) polymer particles have a particle size of less than 2.38 mm and the large poly(arylene sulfide) polymer particles have a particle size of equal to or greater than 2.38 mm; and
(b) contacting at least a portion of the distinguished small poly(arylene sulfide) polymer particles with an aqueous acid solution to form acid treated small poly(arylene sulfide) polymer particles, wherein the aqueous acid solution has a pH of from about 1 to about 8.

A seventeenth embodiment, which is the process of the sixteenth embodiment, wherein the poly(arylene sulfide) polymer has a particle size distribution equal to or greater than 10 wt. % large poly(arylene sulfide) polymer particles.

An eighteenth embodiment, which is the process of any of the sixteenth to the seventeenth embodiments, further comprising recovering the acid treated small poly(arylene sulfide) polymer particles, wherein the acid treated small poly(arylene sulfide) polymer particles have (i) a melt crystallization temperature of from about 180° C. to about 250° C., and (ii) a sodium content of less than about 300 ppm, based on the weight of the acid treated small poly(arylene sulfide) polymer particles.

A nineteenth embodiment, which is the process of any of the sixteenth to the eighteenth embodiments, wherein distinguishing at least a portion of the small poly(arylene sulfide) polymer particles from the large poly(arylene sulfide) polymer particles comprises separating at least a portion of the small poly(arylene sulfide) polymer particles from the large poly(arylene sulfide) polymer particles to yield the distinguished small poly(arylene sulfide) polymer particles.

A twentieth embodiment, which is the process of any of the sixteenth to the eighteenth embodiments, wherein distinguishing at least a portion of the small poly(arylene sulfide) polymer particles from the large poly(arylene sulfide) polymer particles comprises mechanically reducing the size of at least a portion of the large poly(arylene sulfide) polymer particles to yield the distinguished small poly(arylene sulfide) polymer particles.

A twenty-first embodiment, which is the process of any of the sixteenth to the eighteenth embodiments, wherein distinguishing at least a portion of the small poly(arylene sulfide) polymer particles from the large poly(arylene sulfide) polymer particles comprises (i) separating at least a portion of the small poly(arylene sulfide) polymer particles from the large poly(arylene sulfide) polymer particles to yield separated small poly(arylene sulfide) polymer particles and separated large poly(arylene sulfide) polymer particles and (ii) mechanically reducing the size of at least a portion of the separated large poly(arylene sulfide) polymer particles to yield mechanically sized small poly(arylene sulfide) polymer particles; and further comprising:

combining at least a portion of the separated small poly(arylene sulfide) polymer particles and at least a portion of the mechanically sized small poly(arylene sulfide) polymer particles to yield the distinguished small poly(arylene sulfide) polymer particles prior to (b) contacting with an aqueous acid solution.

A twenty-second embodiment, which is the process of any of the sixteenth to the twenty-first embodiments, further comprising reacting a sulfur source and a dihaloaromatic compound in the presence of a polar organic compound to form the poly(arylene sulfide) polymer.

A twenty-third embodiment, which is the process of any of the sixteenth to the twenty-second embodiments, wherein the poly(arylene sulfide) is a poly(phenylene sulfide).

A twenty-fourth embodiment, which is the process of any of the sixteenth to the twenty-third embodiments, wherein the aqueous acid solution is an aqueous acetic acid solution.

A twenty-fifth embodiment, which is the process of the sixteenth to the twenty-fourth embodiments, wherein the contacting at least a portion of the distinguished small poly(arylene sulfide) polymer particles with an aqueous acid solution increases the melt crystallization temperature of the resultant acid treated small poly(arylene sulfide) polymer particles when compared to the melt crystallization temperature of the distinguished small poly(arylene sulfide) polymer particles prior to (b) contacting with an aqueous acid solution.

A twenty-sixth embodiment, which is a process comprising:
(a) beginning with a poly(phenylene sulfide) polymer comprising a plurality of small poly(phenylene sulfide) polymer particles and large poly(phenylene sulfide) polymer particles, distinguishing at least a portion of the small poly(phenylene sulfide) polymer particles from the large poly(phenylene sulfide) polymer particles to yield distinguished small poly(phenylene sulfide) polymer particles, wherein the small poly(phenylene sulfide) polymer particles have a particle size of less than 2.38 mm and the large poly(phenylene sulfide) polymer particles have a particle size of equal to or greater than 2.38 mm; and
(b) contacting at least a portion of the distinguished small poly(phenylene sulfide) polymer particles with an aqueous acetic acid solution to form acid treated small poly(phenylene sulfide) polymer particles, wherein the aqueous acetic acid solution has a pH of from about 1 to about 8.

A twenty-seventh embodiment, which is the process of the twenty-sixth embodiment, wherein the poly(phenylene sulfide) polymer has a particle size distribution equal to or greater than 10 wt. % large poly(phenylene sulfide) polymer particles.

A twenty-eighth embodiment, which is the process of any of the twenty-sixth to the twenty-seventh embodiments, further comprising recovering the acid treated small poly(phenylene sulfide) polymer particles, wherein the acid treated small poly(phenylene sulfide) polymer particles have (i) a melt crystallization temperature of from about 180° C. to about 250° C., and (ii) a sodium content of less than about 300 ppm, based on the weight of the acid treated small poly(phenylene sulfide) polymer particles.

A twenty-ninth embodiment, which is the process of any of the twenty-sixth to the twenty-eighth embodiments, wherein distinguishing at least a portion of the small poly(phenylene sulfide) polymer particles from the large poly(phenylene sulfide) polymer particles comprises separating at least a portion of the small poly(phenylene sulfide) polymer particles from the large poly(phenylene sulfide) polymer particles to yield the distinguished small poly(phenylene sulfide) polymer particles.

A thirtieth embodiment, which is the process of the twenty-sixth to the twenty-eighth embodiments, wherein distinguishing at least a portion of the small poly(phenylene sulfide) polymer particles from the large poly(phenylene sulfide) polymer particles comprises mechanically reducing the size of at least a portion of the large poly(phenylene sulfide) polymer particles to yield the distinguished small poly(phenylene sulfide) polymer particles.

A thirty-first embodiment, which is the process of any of the twenty-sixth to the twenty-eighth embodiments, wherein distinguishing at least a portion of the small poly(phenylene sulfide) polymer particles from the large poly(phenylene sulfide) polymer particles comprises (i) separating at least a portion of the small poly(phenylene sulfide) polymer particles from the large poly(phenylene sulfide) polymer particles to yield separated small poly(phenylene sulfide) polymer particles and separated large poly(phenylene sulfide) polymer particles and (ii) mechanically reducing the size of at least a portion of the separated large poly(phenylene sulfide) polymer particles to yield mechanically sized small poly(phenylene sulfide) polymer particles; and further comprising:

combining at least a portion of the separated small poly(phenylene sulfide) polymer particles and at least a portion of the mechanically sized small poly(phenylene sulfide) polymer particles to yield the distinguished small poly(phenylene sulfide) polymer particles prior to (b) contacting with an aqueous acetic acid solution.

A thirty-second embodiment, which is the process of any of the twenty-sixth to the thirty-first embodiments, wherein the contacting at least a portion of the distinguished small poly(phenylene sulfide) polymer particles with an aqueous acetic acid solution increases the melt crystallization temperature of the resultant acid treated small poly(phenylene sulfide) polymer particles when compared to the melt crystallization temperature of the distinguished small poly(phenylene sulfide) polymer particles prior to (b) contacting with an aqueous acetic acid solution.

A thirty-third embodiment, which is a process comprising:
(a) beginning with a poly(phenylene sulfide) polymer comprising a plurality of small poly(phenylene sulfide) polymer particles and large poly(phenylene sulfide) polymer particles, distinguishing at least a portion of the small poly(phenylene sulfide) polymer particles from the large poly(phenylene sulfide) polymer particles to yield distinguished small poly(phenylene sulfide) polymer particles, wherein the small poly(phenylene sulfide) polymer particles have a particle size of less than 2.38 mm and the large poly(phenylene sulfide) polymer particles have a particle size of equal to or greater than 2.38 mm; and
(b) contacting at least a portion of the distinguished small poly(phenylene sulfide) polymer particles with an aqueous metal cation solution to form metal cation treated small poly(phenylene sulfide) polymer particles, wherein the metal cation comprises a calcium cation.

A thirty-fourth embodiment, which is the process of the thirty-third embodiment, wherein the poly(phenylene sulfide) polymer has a particle size distribution equal to or greater than 10 wt. % large poly(phenylene sulfide) polymer particles.

A thirty-fifth embodiment, which is the process of any of the thirty-third to the thirty-fourth embodiments, further comprising recovering the metal cation treated small poly(phenylene sulfide) polymer particles, wherein the metal cation treated small poly(phenylene sulfide) polymer particles have (i) a melt crystallization temperature of from about 180° C. to about 250° C., and (ii) a sodium content of less than about 300 ppm, based on the weight of the metal cation treated small poly(phenylene sulfide) polymer particles.

A thirty-sixth embodiment, which is the process of the thirty-third to the thirty-fifth embodiments, wherein the contacting at least a portion of the distinguished small poly(phenylene sulfide) polymer particles with an aqueous metal cation solution decreases the melt crystallization temperature of the resultant metal cation treated small poly(phenylene sulfide) polymer particles when compared to the melt crystallization temperature of the distinguished small poly(phenylene sulfide) polymer particles prior to (b) contacting with an aqueous metal cation solution.

A thirty-seventh embodiment, which is a process comprising:
(a) beginning with a poly(arylene sulfide) polymer comprising a plurality of small poly(arylene sulfide) polymer particles and large poly(arylene sulfide) polymer particles, distinguishing at least a portion of the small poly(arylene sulfide) polymer particles from the large poly(arylene sulfide) polymer particles to yield distinguished small poly(arylene sulfide) polymer particles, wherein the small poly(arylene sulfide) polymer particles have a particle size of less than 2.38 mm and the large poly(arylene sulfide) polymer particles have a particle size of equal to or greater than 2.38 mm; and
(b) contacting at least a portion of the distinguished small poly(arylene sulfide) polymer particles with an aqueous metal cation solution to form metal cation treated small poly(arylene sulfide) polymer particles, wherein the metal cation comprises a calcium cation.

A thirty-eighth embodiment, which is the process of the thirty-seventh embodiment, wherein the poly(arylene sulfide) polymer has a particle size distribution equal to or greater than 10 wt. % large poly(arylene sulfide) polymer particles.

A thirty-ninth embodiment, which is the process of the thirty-seventh to the thirty-eighth embodiments, further comprising recovering the metal cation treated small poly(arylene sulfide) polymer particles, wherein the metal cation treated small poly(arylene sulfide) polymer particles have (i) a melt crystallization temperature of from about 180° C. to about 250° C., and (ii) a sodium content of less than about 300 ppm, based on the weight of the metal cation treated small poly(arylene sulfide) polymer particles.

A fortieth embodiment, which is the process of any of the thirty seventh to the thirty-ninth embodiments, wherein distinguishing at least a portion of the small poly(arylene sulfide) polymer particles from the large poly(arylene sulfide) polymer particles comprises separating at least a portion of the small poly(arylene sulfide) polymer particles from the large poly(arylene sulfide) polymer particles to yield the distinguished small poly(arylene sulfide) polymer particles.

A forty-first embodiment, which is the process of any of the thirty-seventh to the thirty-ninth embodiments, wherein distinguishing at least a portion of the small poly(arylene sulfide) polymer particles from the large poly(arylene sulfide) polymer particles comprises mechanically reducing the size of at least a portion of the large poly(arylene sulfide) polymer particles to yield the distinguished small poly(arylene sulfide) polymer particles.

A forty-second embodiment, which is the process of any of the thirty-ninth to the forty-first embodiments, wherein distinguishing at least a portion of the small poly(arylene sulfide) polymer particles from the large poly(arylene sulfide) polymer particles comprises (i) separating at least a portion of the small poly(arylene sulfide) polymer particles from the large poly(arylene sulfide) polymer particles to yield separated small poly(arylene sulfide) polymer particles and separated large poly(arylene sulfide) polymer particles and (ii) mechanically reducing the size of at least a portion of the separated large poly(arylene sulfide) polymer particles to yield mechanically sized small poly(arylene sulfide) polymer particles; and further comprising:

combining at least a portion of the separated small poly(arylene sulfide) polymer particles and at least a portion of the mechanically sized small poly(arylene sulfide) polymer particles to yield the distinguished small poly(arylene sulfide) polymer particles prior to (b) contacting with an aqueous metal cation solution.

A forty-third embodiment, which is the process of any of the thirty-seventh to the forty-second embodiments, further comprising reacting a sulfur source and a dihaloaromatic compound in the presence of a polar organic compound to form the poly(arylene sulfide) polymer.

A forty-fourth embodiment, which is the process of any of the thirty-seventh to the forty-third embodiments, wherein the poly(arylene sulfide) is a poly(phenylene sulfide).

A forty-fifth embodiment, which is the process of any of the thirty-seventh to the forty-fourth embodiments, wherein the contacting at least a portion of the distinguished small poly(arylene sulfide) polymer particles with an aqueous metal cation solution decreases the melt crystallization temperature of the resultant metal cation treated small poly(arylene sulfide) polymer particles when compared to the melt crystallization temperature of the distinguished small poly(arylene sulfide) polymer particles prior to (b) contacting with an aqueous metal cation solution.

While embodiments of the disclosure have been shown and described, modifications thereof can be made without departing from the spirit and teachings of the invention. The embodiments and examples described herein are exemplary only, and are not intended to be limiting. Many variations and modifications of the invention disclosed herein are possible and are within the scope of the invention.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the detailed description of the present invention. The disclosures of all patents, patent applications, and publications cited herein are hereby incorporated by reference.

What is claimed is:

1. A process comprising:
(a) beginning with a poly(arylene sulfide) polymer comprising a plurality of small poly(arylene sulfide) polymer particles and large poly(arylene sulfide) polymer particles, distinguishing at least a portion of the small poly(arylene sulfide) polymer particles from the large poly(arylene sulfide) polymer particles to yield distinguished small poly(arylene sulfide) polymer particles, wherein the small poly(arylene sulfide) polymer particles have a particle size of less than 2.38 mm and the large poly(arylene sulfide) polymer particles have a particle size of equal to or greater than 2.38 mm; and
(b) contacting at least a portion of the distinguished small poly(arylene sulfide) polymer particles with an aqueous solution to form treated small poly(arylene sulfide) polymer particles.

2. The process of claim 1, wherein the poly(arylene sulfide) polymer has a particle size distribution equal to or greater than 10 wt. % large poly(arylene sulfide) polymer particles.

3. The process of claim 1, further comprising recovering the treated small poly(arylene sulfide) polymer particles, wherein the treated small poly(arylene sulfide) polymer particles have (i) a melt crystallization temperature of from about 180° C. to about 250° C., and (ii) a sodium content of less than about 300 ppm, based on the weight of the treated small poly(arylene sulfide) polymer particles.

4. The process of claim 3, wherein the treated small poly(arylene sulfide) polymer particles have a melt crystallization temperature of from about 220° C. to about 240° C.

5. The process of claim 1, wherein distinguishing at least a portion of the small poly(arylene sulfide) polymer particles from the large poly(arylene sulfide) polymer particles comprises separating at least a portion of the small poly(arylene sulfide) polymer particles from the large poly(arylene sulfide) polymer particles to yield the distinguished small poly(arylene sulfide) polymer particles.

6. The process of claim 1, wherein distinguishing at least a portion of the small poly(arylene sulfide) polymer particles from the large poly(arylene sulfide) polymer particles comprises mechanically reducing the size of at least a portion of the large poly(arylene sulfide) polymer particles to yield the distinguished small poly(arylene sulfide) polymer particles.

7. The process of claim 1, wherein distinguishing at least a portion of the small poly(arylene sulfide) polymer particles from the large poly(arylene sulfide) polymer particles comprises (i) separating at least a portion of the small poly(arylene sulfide) polymer particles from the large poly(arylene sulfide) polymer particles to yield separated small poly(arylene sulfide) polymer particles and separated large poly(arylene sulfide) polymer particles and (ii) mechanically reducing the size of at least a portion of the separated large poly(arylene sulfide) polymer particles to yield mechanically sized small poly(arylene sulfide) polymer particles; and further comprising:
combining at least a portion of the separated small poly(arylene sulfide) polymer particles and at least a portion of the mechanically sized small poly(arylene sulfide) polymer particles to yield the distinguished small poly(arylene sulfide) polymer particles prior to (b) contacting with an aqueous solution.

8. The process of claim 1, further comprising reacting a sulfur source and a dihaloaromatic compound in the presence of a polar organic compound to form the poly(arylene sulfide) polymer.

9. The process of claim 1, wherein the poly(arylene sulfide) is a poly(phenylene sulfide).

10. The process of claim 1, wherein the aqueous solution comprises an aqueous acid solution with a pH of from about 1 to about 8.

11. The process of claim 10, wherein the contacting at least a portion of the distinguished small poly(arylene sulfide) polymer particles with an aqueous acid solution increases the melt crystallization temperature of the resultant treated small poly(arylene sulfide) polymer particles when compared to the melt crystallization temperature of the distinguished small poly(arylene sulfide) polymer particles prior to (b) contacting with an aqueous solution.

12. The process of claim 10, wherein the aqueous acid solution is an aqueous acetic acid solution.

13. The process of claim 1, wherein the aqueous solution comprises an aqueous metal cation solution.

14. The process of claim 13, wherein the metal cation comprises a calcium cation.

15. The process of claim 13, wherein the contacting at least a portion of the distinguished small poly(arylene sulfide) polymer particles with an aqueous metal cation solution decreases the melt crystallization temperature of the resultant treated small poly(arylene sulfide) polymer particles when compared to the melt crystallization temperature of the distinguished small poly(arylene sulfide) polymer particles prior to (b) contacting with an aqueous solution.

16. A process comprising:
(a) beginning with a poly(arylene sulfide) polymer comprising a plurality of small poly(arylene sulfide) polymer particles and large poly(arylene sulfide) polymer particles, distinguishing at least a portion of the small poly(arylene sulfide) polymer particles from the large poly(arylene sulfide) polymer particles to yield distinguished small poly(arylene sulfide) polymer particles, wherein the small poly(arylene sulfide) polymer particles have a particle size of less than 2.38 mm and the large poly(arylene sulfide) polymer particles have a particle size of equal to or greater than 2.38 mm; and
(b) contacting at least a portion of the distinguished small poly(arylene sulfide) polymer particles with an aqueous acid solution to form acid treated small poly(arylene sulfide) polymer particles, wherein the aqueous acid solution has a pH of from about 1 to about 8.

17. The process of claim 16, wherein the contacting at least a portion of the distinguished small poly(arylene sulfide) polymer particles with an aqueous acid solution increases the melt crystallization temperature of the resultant acid treated small poly(arylene sulfide) polymer particles when compared to the melt crystallization temperature of the distinguished small poly(arylene sulfide) polymer particles prior to (b) contacting with an aqueous acid solution.

18. A process comprising:
(a) beginning with a poly(phenylene sulfide) polymer comprising a plurality of small poly(phenylene sulfide) polymer particles and large poly(phenylene sulfide) polymer particles, distinguishing at least a portion of the small poly(phenylene sulfide) polymer particles from the large poly(phenylene sulfide) polymer particles to yield distinguished small poly(phenylene sulfide) polymer particles, wherein the small poly(phenylene sulfide) polymer particles have a particle size of less than 2.38 mm and the large poly(phenylene sulfide) polymer particles have a particle size of equal to or greater than 2.38 mm; and
(b) contacting at least a portion of the distinguished small poly(phenylene sulfide) polymer particles with an aqueous acetic acid solution to form acid treated small poly(phenylene sulfide) polymer particles, wherein the aqueous acetic acid solution has a pH of from about 1 to about 8.

19. The process of claim 18, wherein the contacting at least a portion of the distinguished small poly(phenylene sulfide) polymer particles with an aqueous acetic acid solution increases the melt crystallization temperature of the resultant acid treated small poly(phenylene sulfide) polymer particles when compared to the melt crystallization temperature of the distinguished small poly(phenylene sulfide) polymer particles prior to (b) contacting with an aqueous acetic acid solution.

20. A process comprising:
(a) beginning with a poly(phenylene sulfide) polymer comprising a plurality of small poly(phenylene sulfide) polymer particles and large poly(phenylene sulfide) polymer particles, distinguishing at least a portion of the small poly(phenylene sulfide) polymer particles from the large poly(phenylene sulfide) polymer particles to yield distinguished small poly(phenylene sulfide) polymer particles, wherein the small poly(phenylene sulfide) polymer particles have a particle size of less than 2.38 mm and the large poly(phenylene sulfide) polymer particles have a particle size of equal to or greater than 2.38 mm; and
(b) contacting at least a portion of the distinguished small poly(phenylene sulfide) polymer particles with an aqueous metal cation solution to form metal cation treated small poly(phenylene sulfide) polymer particles, wherein the metal cation comprises a calcium cation.

21. The process of claim 20, wherein the contacting at least a portion of the distinguished small poly(phenylene sulfide) polymer particles with an aqueous metal cation solution decreases the melt crystallization temperature of the resultant metal cation treated small poly(phenylene sulfide) polymer particles when compared to the melt crystallization temperature of the distinguished small poly(phenylene sulfide) polymer particles prior to (b) contacting with an aqueous metal cation solution.

22. A process comprising:
(a) beginning with a poly(arylene sulfide) polymer comprising a plurality of small poly(arylene sulfide) polymer particles and large poly(arylene sulfide) polymer particles, distinguishing at least a portion of the small poly(arylene sulfide) polymer particles from the large poly(arylene sulfide) polymer particles to yield distinguished small poly(arylene sulfide) polymer particles, wherein the small poly(arylene sulfide) polymer particles have a particle size of less than 2.38 mm and the large poly(arylene sulfide) polymer particles have a particle size of equal to or greater than 2.38 mm; and
(b) contacting at least a portion of the distinguished small poly(arylene sulfide) polymer particles with an aqueous metal cation solution to form metal cation treated small poly(arylene sulfide) polymer particles, wherein the metal cation comprises a calcium cation.

23. The process of claim 22, wherein the contacting at least a portion of the distinguished small poly(arylene sulfide) polymer particles with an aqueous metal cation solution decreases the melt crystallization temperature of the resultant metal cation treated small poly(arylene sulfide) polymer particles when compared to the melt crystallization temperature of the distinguished small poly(arylene sulfide) polymer particles prior to (b) contacting with an aqueous metal cation solution.
